(19) United States
(12) Patent Application Publication
(10) Pub. No.: US 2026/0161972 A1
(43) Pub. Date: Jun. 11, 2026

(54) ELECTRONIC PROJECT SYSTEM AND METHOD WITH CUSTOMIZABLE SYSTEM PROMPT BASED ON USER PREFERENCES

(71) Applicant: ipQuants AG, Schaffhausen (CH)

(72) Inventors: Tony Afram, Dachsen (CH); Nikolaos Georgiadis, Thessaloniki (GR)

(21) Appl. No.: 19/356,835

(22) Filed: Oct. 13, 2025

Related U.S. Application Data
(63) Continuation of application No. PCT/IB2024/053630, filed on Apr. 12, 2024.
(60) Provisional application No. 63/496,204, filed on Apr. 14, 2023.
(60) Provisional application No. 63/497,924, filed on Apr. 24, 2023.

(51) Int. Cl. G06N 5/04

(52) U.S. Cl. CPC G06N 5/04

(57) ABSTRACT

A system comprises a processor and a memory. The memory stores a generative AI module and processor instructions. The processor generates a user interface having a project view displaying a project section. The project section comprises a session segment managing a question session; a context segment providing a context field indicative of one or more context source associated with the question session, an IO segment providing a text input field, an answer field; and a prompt input field. The processor further receives the custom prompt input from the prompt input field context field and user request from the text input field; generates, with the AI, an answer to the user request based at least in part on the one or more custom prompt input; and transmits the answer to the answer field of the input-output segment.

### CROSS REFERENCED TO RELATED APPLICATIONS

The present patent application is a continuation of PCT/IB2024/053630, filed on Apr. 12, 2024, which claims priority to the provisional applications identified by U.S. Ser. No. 63/496,204 filed on Apr. 14, 2023, and 63/497,924 filed on Apr. 24, 2023, the entire contents of both of which are hereby incorporated herein by reference.

### FIELD OF THE INVENTION

This disclosure relates to an electronic project system and method, specifically focusing on the creation and customization of system prompts in the field of generative AI engineering.

### DESCRIPTION OF THE PRIOR ART

The drawback with general AI solutions is that they occasionally generate incorrect answers with confidence, so called hallucination, a problem well known to the skilled person. If the user has no subject-matter domain expertise this might lead the user to rely on context that is inaccurate. Thus, the user is therefore used to confirming the answer via a second source. To do so, the user has to navigate away from the AI interaction and rely on other tools and sources. This is very time-consuming and also causes the user to lose focus and concentration, raising the risk of reduce quality in the user task. Additionally, this is more resource intensive due to the user making many manual searches to verify answers via the second source.

A Knowledge worker is an individual who, among others, is tasked with creating, processing and/or utilizing information (e.g., text, audio and/or video information) to generate value in a professional setting. Examples of knowledge workers are paralegals, lawyers, tax consultants, scientist, engineers, corporate strategists, financial analysts, teachers, professors, and the like. A knowledge worker frequently must analyze large set of documents, videos and/or audio materials. Legal, tax, finance, scientific, academic, and similar types of professionals rely on complex document-driven workflows. Such workflows are typically comprised of multiple PDF, WORD, POWER POINT and/or EXCEL (WORD, POWER POINT and EXCEL are trademarks of Microsoft Corporation) documents. Because of the complexity involved, such knowledge workers still rely on printing the project documents on paper, which has negative implications on the environment both because of the paper consumption and the printer consumables consumption, such as ink and toner.

To navigate between different user interfaces and tools is time consuming and a burden for these knowledge workers, that spend significant time of their working hours to manages the interaction between different user interfaces of different tools, such as WORD, EXCEL, POWER POINT and ADOBE PDF viewer. Additionally, when drafting documents, various sections of the document(s) require a different approach and considerations. Generative AI typically requires the user to input pertinent background, thereby introducing error in either poorly formed inputs or erroneous inputs, thereby causing an increase of computing resources when the pertinent background in corrected and/or reintroduced. Thus, also increasing the energy consumption and complexity of the computing infrastructure supporting each knowledge worker.

### SUMMARY OF THE INVENTION

Disclosed herein is a system to provide an electronic project review method and system that overcomes the drawbacks of the known methods and systems and which allows cost efficient review of electronic projects comprising project content to be reviewed, such that an environmentally friendly and cost and time efficient project review is achieved.

Moreover, the problem of generative AI requiring the user to input pertinent background is solved by the electronic project system disclosed herein. The electronic project system comprises a processor and a memory. The memory comprises a non-transitory processor-readable medium storing processor-readable instructions that when executed by the processor cause the processor to: generate a user interface having a project view configured to display one or more project section, each project section having a content related to an electronic project; wherein the one or more project section comprises: a session management segment configured to manage one or more question-and-answer sessions; a context management segment configured to provide one or more context field to a user, the one or more context field indicative of one or more context source associated with the one or more question-and-answer session, the content including at least the one or more context source; an input-output segment configured to provide a text input field, and a generated answer field; and a prompt input field.

The processor further receives one or more custom prompt input from the prompt input field of the user interface as a custom prompt input; receives one or more text input from the user interface, the text input being indicative of one or more user request; generates an answer to the one or more user request based at least in part on the custom prompt input; and transmits the generated answer to the generated answer field of the input-output segment of the user interface.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a diagram of an exemplary embodiment of hardware forming a system constructed in accordance with the present disclosure.

FIG. 2 is a screenshot of an exemplary user interface constructed in accordance with the present disclosure.

FIG. 3 is another screenshot of an exemplary user interface constructed in accordance with the present disclosure.

FIG. 4 is another screenshot of an exemplary user interface constructed in accordance with the present disclosure.

FIG. 5 is an exemplary embodiment of a portion of the output area of FIG. 4 showing a second question asked in the second session.

FIG. 6 is another screenshot of an exemplary user interface further having stacked sections constructed in accordance with the present disclosure.

FIG. 7 is another screenshot of an exemplary user interface further having a keyword pane constructed in accordance with the present disclosure.

FIG. 8 is another screenshot of an exemplary user interface further having a results pane constructed in accordance with the present disclosure.

FIG. 9 is another screenshot of an exemplary user interface showing a second project section in “draft mode” and constructed in accordance with the present disclosure.

FIG. 10 is another screenshot of an exemplary user interface showing a text editor after exiting “draft mode” and constructed in accordance with the present disclosure.

FIG. 11 is another screenshot of an exemplary user interface further having more than one project view and constructed in accordance with the present disclosure.

FIG. 12 is a relationship diagram of an exemplary embodiment of one or more system prompt 200 herein described.

FIG. 13 is another screenshot of an exemplary user interface further showing one or more prompt inputs constructed in accordance with the present disclosure.

FIG. 14 is a process flow diagram of an exemplary embodiment of a prompt generation process constructed in accordance with the present disclosure.

FIG. 15 is another screenshot of an exemplary user interface further showing a text editor project panel after receiving a third instruction.

FIG. 16 is another screenshot of an exemplary user interface further showing the text editor project panel of FIG. 15 after receiving a fourth instruction.

FIG. 17 is another screenshot of an exemplary user interface further showing the text editor project panel of FIG. 16 after receiving a fifth instruction.

FIG. 18 is another screenshot of an exemplary user interface further showing the text editor project panel of FIG. 17 after receiving a sixth instruction.

FIG. 19 is another screenshot of an exemplary user interface further showing a landscape dashboard panel for automatic patentability analysis constructed in accordance with the present disclosure.

### DETAILED DESCRIPTION

Before explaining at least one embodiment of the disclosure in detail, it is to be understood that the disclosure is not limited in its application to the details of construction, experiments, exemplary data, and/or the arrangement of the components set forth in the following description or illustrated in the drawings unless otherwise noted. The disclosure is capable of other embodiments or of being practiced or carried out in various ways. Also, it is to be understood that the phraseology and terminology employed herein is for purposes of description and should not be regarded as limiting.

As used in the description herein, the terms “comprises,” “comprising,” “includes,” “including,” “has,” “having,” or any other variations thereof, are intended to cover a non-exclusive inclusion. For example, unless otherwise noted, a process, method, article, or apparatus that comprises a list of elements is not necessarily limited to only those elements but may also include other elements not expressly listed or inherent to such process, method, article, or apparatus.

Further, unless expressly stated to the contrary, “or” refers to an inclusive and not to an exclusive “or”. For example, a condition A or B is satisfied by one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more, and the singular also includes the plural unless it is obvious that it is meant otherwise. Further, use of the term “plurality” is meant to convey “more than one” unless expressly stated to the contrary.

As used herein, qualifiers like “substantially,” “about,” “approximately,” and combinations and variations thereof, are intended to include not only the exact amount or value that they qualify, but also some slight deviations therefrom, which may be due to computing tolerances, computing error, manufacturing tolerances, measurement error, wear and tear, stresses exerted on various parts, and combinations thereof, for example.

As used herein, any reference to “one embodiment,” “an embodiment,” “some embodiments,” “one example,” “for example,” or “an example” means that a particular element, feature, structure, or characteristic described in connection with the embodiment is included in at least one embodiment and may be used in conjunction with other embodiments. The appearance of the phrase “in some embodiments” or “one example” in various places in the specification is not necessarily all referring to the same embodiment, for example.

The use of ordinal number terminology (i.e., “first”, “second”, “third”, “fourth”, etc.) is solely for the purpose of differentiating between two or more items and, unless explicitly stated otherwise, is not meant to imply any sequence or order of importance to one item over another.

The use of the term “at least one” or “one or more” will be understood to include one as well as any quantity more than one. In addition, the use of the phrase “at least one of X, Y, and Z” will be understood to include X alone, Y alone, and Z alone, as well as any combination of X, Y, and Z.

Where a range of numerical values is recited or established herein, the range includes the endpoints thereof and all the individual integers and fractions within the range, and also includes each of the narrower ranges therein formed by all the various possible combinations of those endpoints and internal integers and fractions to form subgroups of the larger group of values within the stated range to the same extent as if each of those narrower ranges was explicitly recited. Where a range of numerical values is stated herein as being greater than a stated value, the range is nevertheless finite and is bounded on its upper end by a value that is operable within the context of the invention as described herein. Where a range of numerical values is stated herein as being less than a stated value, the range is nevertheless bounded on its lower end by a non-zero value. It is not intended that the scope of the invention be limited to the specific values recited when defining a range. All ranges are inclusive and combinable.

Circuitry, as used herein, may be analog and/or digital components, or one or more suitably programmed processors (e.g., microprocessors) and associated hardware and software, or hardwired logic. Also, “components” may perform one or more functions. The term “component,” may include hardware, such as a processor (e.g., microprocessor), an application specific integrated circuit (ASIC), a field programmable gate array (FPGA), a combination of hardware and software, software, and/or the like. The term “processor” as used herein means a single processor or multiple processors working independently or together to collectively perform a task.

Software may include one or more computer readable instruction that when executed by one or more component, e.g., a processor, causes the component to perform a specified function. It should be understood that the algorithms described herein may be stored on one or more non-transitory computer-readable medium. Exemplary non-transitory computer-readable mediums may include a non-volatile memory, a random-access memory (RAM), a read only memory (ROM), a flash memory, a CD-ROM, a hard drive, a solid-state drive, a flash drive, a memory card, a DVD-ROM, a Blu-ray Disk, a laser disk, a magnetic disk, a magnetic tape, an optical drive, combinations thereof, and/or the like.

Such non-transitory computer-readable mediums may be electrically based, optically based, magnetically based, resistive based, and/or the like. Further, the messages described herein may be generated by the components and result in various physical transformations.

As used herein, the terms “network-based,” “cloud-based,” and any variations thereof, are intended to include the provision of configurable computational resources on demand via interfacing with a computer and/or computer network, with software and/or data at least partially located on a computer and/or computer network.

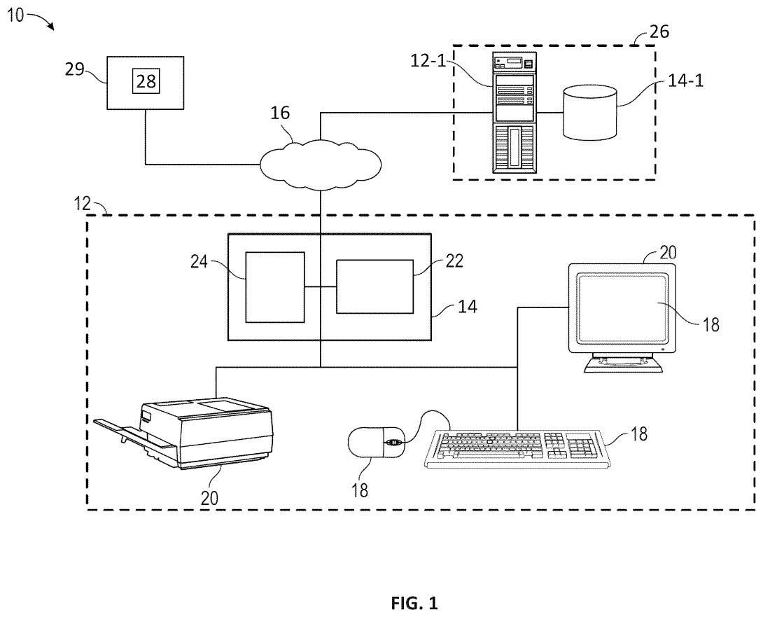

Referring now to the drawings, and in particular to FIG. 1, shown therein is a diagram of an exemplary embodiment of a computing system 10 constructed in accordance with the present disclosure. The computing system 10 includes one or more processor 12. The one or more processor 12 may work to execute processor executable code. The one or more processors 12 may be implemented as a single or plurality of processors working together or independently to execute the logic as described herein. Exemplary embodiments of the one or more processors 12 may include, but are not limited to, a digital signal processor (DSP), a central processing unit (CPU), a field programmable gate array (FPGA), a microprocessor, a multi-core processor, an application specific integrated circuit (ASIC), a Tensor processing Unit (TPU), a graphical processing unit (GPU), and/or combinations thereof, for example. In some embodiments, the one or more processors 12 may be incorporated into a smart device. The one or more processors 12 may be capable of communicating via a network 16 or a separate network (e.g., analog, digital, optical and/or the like). It is to be understood, that in certain non-limiting embodiments, using more than one processor, the processors 12 may be located remotely from one another, in the same location, or comprising a unitary multi-core processor. In some non-limiting embodiments, the one or more processors 12 may be partially or completely network-based or cloud-based, and may or may not be located in a single physical location.

The one or more processors 12 may be configured to read and/or execute processor executable code and/or configured to create, manipulate, retrieve, alter and/or store data structure into one or more memory 14. In some embodiments, the one or more processors 12 may include one or more memory 14. The one or more memory 14 may be one or more non-transient memory comprising processor executable code and may store processor-executable code (such as software application(s)) that when executed by the one or more processor 12 causes the one or more processor 12 to perform a particular function. In some non-limiting embodiments, the one or more memory 14 may be located at the same physical location as the processor 12. Alternatively, one or more memory 14 may be located at a different physical location as the processor 12 and communicate with the processor 12 via a network, such as a network 16. Additionally, one or more memory 14 may be implemented as a “cloud memory” (i.e., one or more memories may be partially or completely based on or accessed using a network, such as the network 16). The one or more memory 14 may store processor executable code and/or information comprising at least one database 22 and program logic 24 (i.e., computer executable logic, software application). In some non-limiting embodiments, the processor executable code may be stored as a data structure, such as a database and/or data table, for example. In use, the one or more processor 12 may execute the program logic 24 controlling the reading, manipulation and/or storing of data as detailed in the methods described herein. In some embodiments, at least one database 22 may include a project database.

In some non-limiting embodiments, the one or more processor 12 may transmit and/or receive data via the network 16. The network 16 may be implemented as a wireless network, a local area network (LAN), a wide area network (WAN), a metropolitan network, a cellular network, a Global System of Mobile Communication (GSM) network, a code division multiple access (CDMA) network, a 4G network, a 5G network, a satellite network, a radio network, an optical network, an Ethernet network, combinations thereof, and/or the like. Additionally, the network 16 may use a variety of network protocols to permit bi-directional interface and/or communication of data and/or information. It is conceivable that in the near future, embodiments of the present disclosure may use more advanced networking topologies. In some non-limiting embodiments, the network 16 may transmit and/or receive data via the network 16 to and/or from one or more external system (e.g., one or more external computer systems, one or more machine learning applications, artificial intelligence, cloud-based system, microphones, and the like). In some non-limiting embodiments, the one or more processor 12 may be provided on a cloud cluster (i.e., a group of nodes hosted on virtual machines and connected within a virtual private cloud).

In some non-limiting embodiments, the one or more processors 12 may include one or more input devices 18 and one or more output devices 20. The one or more input devices 18 may be configured to receive information from a user, processor(s), and/or environment, and transmit such information to the one or more processors 12 and/or the network 16. The one or more input devices 18 may include, but are not limited to, implementation as a keyboard, touchscreen, mouse, trackball, microphone, fingerprint reader, infrared port, slide-out keyboard, flip-out keyboard, smart phone, cell phone, remote control, network interface, speech recognition device, gesture recognition device, combinations thereof, and/or the like.

The one or more output devices 20 may be configured to provide data in a form perceivable to a user and/or processors. The one or more output devices 20 may include, but are not limited to, implementations as a monitor, a screen, a touchscreen, a speaker, a website, a television set, a smart phone, a cell phone, a printer, a laptop computer, an optical head-mounted display, combinations thereof, and/or the like. In some non-limiting embodiments, the one or more input devices 18 and the one or more output devices 20 may be implemented as a single device, such as, for example, a touchscreen or tablet.

In one embodiment, the computing system 10 is connected, e.g., via the network 16, to an electronic project system 26. In some embodiments, the electronic project system 26 may be included within the one or more processors 12. In some embodiments, the electronic project system 26 may include a separate processor 12-1 and a separate memory 14-1, linked by way of high-speed bus. The processor 12-1 and the memory 14-1 of the electronic project system 26 may be implemented in a similar manner as the one or more processor 12 and the memory 14, e.g., the non-transitory processor-readable medium storing processor executable-instructions, described herein.

In one embodiment, the program logic 24 (e.g., the processor-executable code) may include software to enable implementation of a method and system for facilitating review of an electronic project and associated project content. The electronic project in this embodiment is for example a project that enables review of one or more document that can be retrieved from the at least one database 22, following a search in the electronic project system 26.

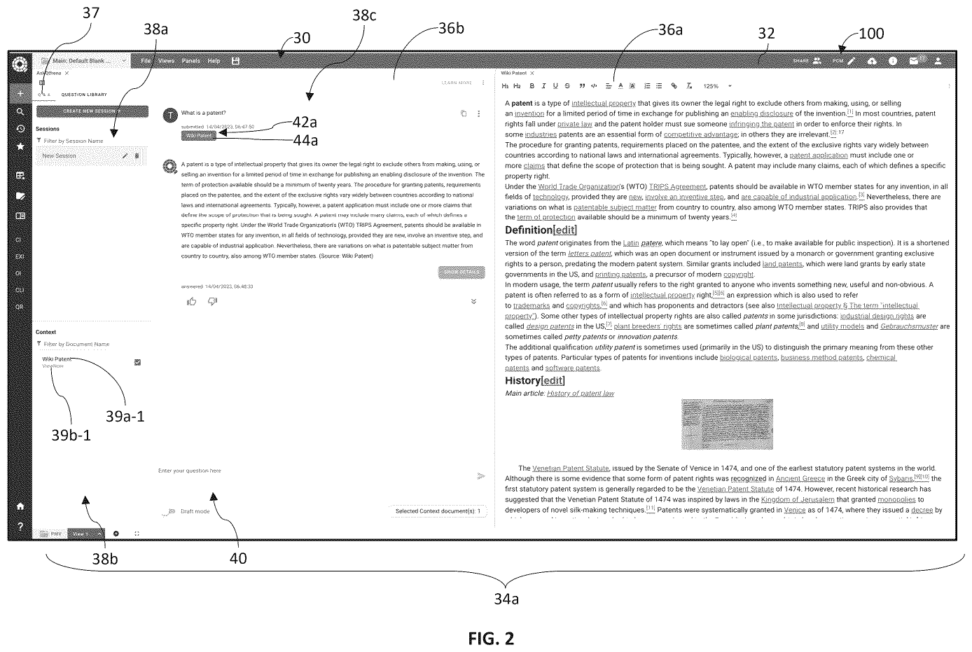

Referring to FIG. 1 and FIG. 2, in one embodiment, the computing system 10 is configured to provide a review of an electronic project 30 via a user interface 32. The user interface 32 may be provided via program logic 24 and controllable via the one or more processor 12 by way of input device 18. In some embodiments, the user interface 32 may be accessible via multiple processors 12 such that a plurality of users (such as one or more knowledge worker) may access the user interface 32, and in some embodiments, such access may be simultaneous. In some embodiments, the user interface 32 may be provided via the network 16 (e.g., via Internet access) to a server computer (e.g., the electronic project system 26) arranged to serve pages forming part of the user interface 32. In another embodiment, the user interface 32 may be configured via one or more software packages stored locally on the memory 14 and accessible by the processor 12. In some non-limiting embodiments, the computing system 10 may enable access to the electronic project simultaneously via multiple user devices.

Referring now to FIG. 2, shown therein is a screenshot 100 of an exemplary user interface 32 for the project owner of the electronic project 30 and is configured to be edited, manipulated and/or viewed by one or more users via the computing system 10. The electronic project system 26 hosts the one or more electronic project 30. In one embodiment, the screenshot 100 of the electronic project 30 shows one or more project view 34, shown in FIG. 2 as a first project view 34a. The one or more project view 34 can display data, including but not limited to content to be reviewed, such as in one or more project section 36.

The first project view 34a as shown in FIG. 2 has a first project section 36a and a second project section 36b. The first project section 36a may be a text editor project panel wherein the user can insert and edit text and similar content.

The first project section 36a and the second project section 36b can also be referred as project panels and are re-arrangeable within each project view 34 in a grid-like layout. In this way, the user may customize an arrangement of the project sections 36 in a particular project view 34. In one embodiment, the user can also add more project sections 36 and/or delete existing project sections 36 at any time, e.g., by interacting with one or more of the input devices 18.

In one embodiment, the second project section 36b is a question-and-answer project section, which comprises a first segment 38a as a session management segment, a second segment 38b as a context management segment, and a third segment 38c as an input-and-output segment. The second project section 36b comprises a mode management segment, which enables the user to access different modes of a generative AI module 24-1 (also referred to herein as a generative AI assistant). The second project section 36b is currently in the Q&A mode as this mode management segment is currently selected by the user as shown by a mode indicator 37.

In one embodiment, the generative AI module 24-1 is a software application, such as the program logic 24 executing in the processor 12. The generative AI module 24-1 may be constructed of one or more artificial intelligence or machine learning model. The generative AI module 24-1 may be constructed using one or more learning paradigm, such as supervised learning, unsupervised learning, reinforcement learning, self-learning, and neuroevolutionary learning, and/or the like or a combination thereof. In one embodiment, the generative AI module 24-1 may be executed on one or more graphics processor unit in communication with or integrated with the processor 12, or, in some embodiments, may be executed by the processor 12. In one embodiment, specially designed machine learning hardware may be used to executed the generative AI model. In one embodiment, the generative AI module 24-1 comprises one or more of a GPT model, a BERT model, a Transformer-XL model, or another natural language model operable to provide one or more natural language response.

In one embodiment, the generative AI module 24-1 is more than one artificial intelligence model. For example, in one embodiment, the generative AI module 24-1 may be a first artificial intelligence model supervising one or more second artificial intelligence model. The one or more second artificial intelligence model may be executed by the same hardware components that execute the first artificial intelligence model. For example, the second artificial intelligence model may be executed by one or more processor of the same one or more processor 12 that executes the first artificial intelligence. In one embodiment, the first artificial intelligence model may be in communication with the second artificial intelligence model via the network 16, for example, by utilizing one or more application programming interface (API). Further, in some embodiments, the generative AI module 24-1 may be a first artificial intelligence model and may be in communication with one or more third-party artificial intelligence model 28 (FIG. 1) running on one or more third-party computer system 29 (FIG. 1), processor, and/or memory. In one embodiment, the generative AI module 24-1 may be executed by one or more processor on a user device, e.g., the generative AI module 24-1 may be run locally.

In one embodiment, a question and/or instruction inserted by the user via an input box 40 will be displayed in the third segment 38c, i.e., the input-and-output segment, as well as an answer or response corresponding to the particular question and/or instruction, as described below in more detail.

In one embodiment, the input box 40 is a multi-modal input box operable to receive at least one input from the one or more input device 18. Any user input provided to the input box 40 may be accessed by the processor 12 executing the generative AI. In one embodiment, the generative AI may process the user input without first converting the user input into text. By supporting multi-modal input, such as through voice commands, gestures, or biometric inputs in addition to text-based inputs, the user interface 32 has a reduced complexity from the user's point of view and offers a more natural and intuitive user experience, thereby catering to a wider range of users with diverse preferences and requirements.

In one embodiment, for example, the one or more input device 18 can be configured to capture one or more voice command from the user, which can then be processed by the one or more processors 12 and used as input for the generative AI module 24-1. In this scenario, the generative AI module 24-1 may employ natural language processing techniques to interpret and understand the user's voice commands and generate appropriate responses accordingly. Further, in some embodiments, one or more first voice command may be provided to the computing system 10, such as “Create a new session named ‘Session29’ and select the context ‘D1’ and ‘D2.’” This voice command may be received by the computing system 10 via the one or more input device 18 and be processed by the processor 12 executing the generative AI module 24-1 to determine and act on the command, in this case, creating a new session 47 and selecting source documents D1 and D2, e.g., by selecting one or more check-box input 55 corresponding to the source documents D1 and D2. In one embodiment, the user may continue with a second voice command of “ask the question ‘Do any of the documents disclose XYZ?’.” The second voice command may be received by the computing system 10 via the one or more input device 18 and be processed by the processor 12 executing the generative AI module 24-1 to provide the question of the second voice command as input to the input box 40 as a question 51 to which the processor 12 executing the generative AI module 24-1 may subsequently provide a generated answer 50, without, at least in some embodiments, further input from the user. In one embodiment, the one or more first voice command and the second voice command may be combined into a single voice command without further affecting processing of either voice command.

Similarly, in another embodiment, the one or more input device 18 may also include gesture recognition devices, such as cameras or motion sensors, enabling users to control the computing system 10 through various hand gestures or body movements. This embodiment facilitates a more interactive and engaging user experience, particularly for users who prefer non-text-based input methods.

In another embodiment, a multi-modal input feature can be extended to incorporate biometric inputs, such as fingerprint or facial recognition, for enhanced security and personalized user experiences. For example, users can log into the electronic project 30 using their unique biometric information, ensuring secure access to the project content and personalized user settings. By integrating multi-modal input features into the computing system 10, the overall usability and appeal of the system are significantly improved, thus freeing computer resources that would otherwise be used by third-party applications to process various multi-modal inputs.

In one embodiment, as shown in FIG. 2, the user has selected a first context source 42a, illustrated as “Wiki Patent” and asked the question “What is a patent?”. Information regarding how many context documents have been selected is visualized to the user via a first context indicator 44a. By visualizing to the user, e.g., via the user interface 32, the first context indicator 44a, the user can be confident that the questions and instructions asked in the input box 40 are executed against the desired source document (e.g., context source 42) and the user is made aware of the context source. Further, the user may readily view, and thus be aware, of not only a context document was selected, but also, specifically, which context document was selected.

In one embodiment, the context management segment 38b may further display project content regarding an available context source 39a and a context format 39b of the available context source 39a. In one embodiment, the project content may include more than one available context source 39a where each available context source 39a has the context format 39b. In one embodiment, the available context sources 39a may be any type of digital media file having the same or different encoding schemes, such as a text-based document (for example, PDF file(s), WORD file(s), EXCEL file(s), PowerPoint file(s) (WORD, EXCEL and PowerPoint are trademarks of Microsoft), text files, RTF files, source code files, and/or the like), an audio-based document (for example, MP3, waveform audio format (WAV), Windows Media Audio (WMA), OGG, Advanced Audio Coding (AAC), or Free Lossless Audio Codec (FLAC) files, audiobook files, and/or the like), and/or a video-based document (for example, MP4, MOV, Audio Video Interleave (AVI), MKV, Windows Media Video (WMV), WEBM, and/or the like). In one embodiment, the processor 12 may convert the available context sources 39a to a text-based format for ingestion by the generative AI module 24-1 when the available context sources 39a are added to the context management segment 38b and/or when the available context sources 39a are selected by the user for use by the generative AI. In some embodiments, the available context sources 39a are not converted to text, and are instead supplied to an AI (or transformer) configured to transform the available context source 39a to a format (such as a vector) accessible to the generative AI context.

In this way, the user is also informed via the second segment 38b (e.g., the context management segment) about the available context sources 39a and the context format 39b for each of the available context sources 39a. As shown in FIG. 2, the available context source 39a-1 is a “Wiki Patent” context source having a context format 39b-1 as text stored in a “ViewNote” section of the electronic project 30, which is shown in the first project section 36a constructed as a text section or text panel of the electronic project 30. Further, the available context sources 39a may be associated with the one or more check-box input 55, which upon selection by the user, causes the associated available context source 39a to be one of the context sources 42. As shown, selection of a check-box input 55-1 associated with the available context source 39a-1 of “Wiki Patent” causes the available context source 39a-1 to become, or be included as, the first context source 42a of “Wiki Patent.” Such selection may be stored, for example, by the processor 12 in the memory 14.

In one embodiment, the user may select or deselect one or more of the available context sources 39a to control what context is utilized by the generative AI module 24-1, such as by selection of the one or more check-box input 55 associated with a particular available context source 39a. In other words, the user is in control and informed from the single user interface 32 about the available context sources 39a and their respective context format 39b. This provides trust in the generated answers, since the user is fully informed from a single view about the questions, the answer, the source on the basis of which the question was answered and the format of the source on the basis of which the question was answered. Further, providing the available context sources 39a and their respective context format 39b within the user interface 32 to the user may be at least one component of the technical solution of overcoming the technical problem of generative AI hallucination and/or overconfidence in incorrect generated answers.

In one embodiment, the second segment 38b (e.g., the context segment) further displays one or more source document property (e.g., a context format 39b) of a source document (e.g., an available context source 39a). For example, the second segment 38b may display source document properties, including a document/context format, a document timestamp, a document language, a document OCR confidence, a document author, and/or the like, thereby further overcoming issues with generative AI hallucination. When the source document is in a language other than a preferred language identified by the user, e.g., in user settings, the electronic project 30 offers the user an option to control whether an original language for the source document is going to be displayed and/or processed by the processor 12 executing the generative AI module 24-1 to generate the generated answer or if the user prefers the processor 12 execute a machine learning translation of the original language (not shown). This feature allows the user to have a better understanding of the context source and the generated answer while working with source documents in different languages. Further, by incorporating real-time translation capabilities using advanced machine learning techniques, the computing system 10 caters to a diverse user base and ensures that the AI-generated answers are aligned with the user's preferred language and comprehension level, thereby improving the overall user experience and the system's effectiveness and efficiency by only translating documents as requested by the user.

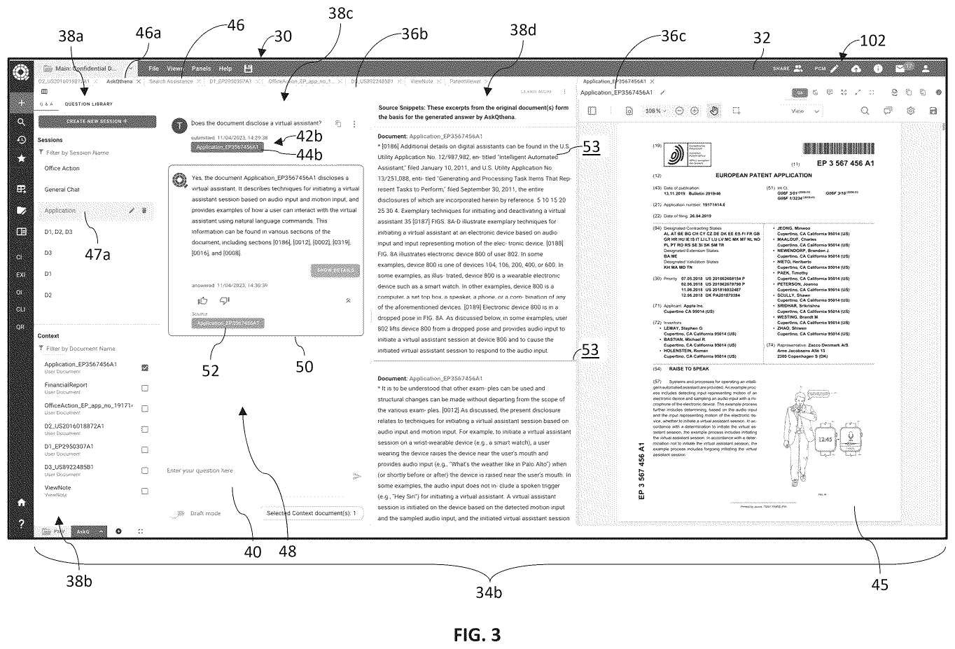

Referring now to FIG. 3, shown therein is an exemplary embodiment of a screenshot 102 of the exemplary user interface 32 for the project owner of the electronic project 30 and is configured to be edited, manipulated and/or viewed by one or more users via the computing system 10. In one embodiment, as shown in the screenshot 102, the user interface 32 has a second project view 34b. The second project view 34b may display one or more project section 36, such as the second project section 36b and a third project section 36c. As shown in the screenshot 102, the second project section 36b is arranged side-by-side with the third project section 36c. The third project section 36c may be a document view and/or document editor and is shown as displaying a source document 45, shown, for example, as a PDF document of a second context source 42b.

Further, and as shown in FIG. 3, one or more additional project section 36 may be “stacked” as indicated by one or more tab 46, each of which may correspond to a particular one of the one or more project section 36. In one embodiment, a particular tab 46 may be highlighted or otherwise identified when the particular tab 46 corresponds to the second project section 36b displayed in the second project view 34b of the user interface 32, as shown by a first tab 46a.

In one embodiment, as shown in FIG. 3, further Q&A sessions have been created and are listed in the first segment 38a (i.e., the session management segment). In addition, further context sources 42 have been added to the project and are available for the user to select under the second segment 38b as indicated by a second available context source 39a-2 and second check-box input 55-2. As shown by a second context indicator 44b, the second available context source 39a-2 has been selected by the user and is provided as a second context source 42b for use by the generative AI.

The user has currently selected the second context source 42b, shown as “Application_EP3567456A1” and has asked a question, e.g., via the input box 40, and received an answer as shown in the third segment 38c (e.g., the input-and-output segment) within first session 47a, shown as “Application” in the first segment 38a.

A generated answer provided by the generative AI module 24-1 is displayed within an output area 48. The output area 48 comprises the generated answer 50, context source information area 52 which indicates one or more source document (e.g., the second context source 42b having the second available context source 39a-2) that was utilized in generating the generated answer 50. In this manner, further valuable information is provided such that the user is provided with a source for output information (e.g., the generated answer 50) and saves significant time in avoiding the need to scroll away or open a separate document each time a generated answer 50 is provided in order to verify that the source document (e.g., the second context source 42b) is relevant to the question asked. In other words, providing context-aware feedback (e.g., the context source information area 52 indicating the one or more source document) within the user interface 32 to the user may be at least one component of the technical solution of overcoming the technical problem of generative AI hallucination and/or overconfidence in incorrect generated answers. In one embodiment, the generated answer 50 is provided as a natural language response.

In one embodiment, user interaction with the output area 48, for example by clicking an icon or similar, may cause the electronic project system 26 to open a fourth segment 38d in the second project section 36b. The fourth segment 38d may be a context source segment wherein one or more source snippet 53 is displayed. For example, in the case of a text-based document, the one or more source snippet 53 may be a text snippet most relevant for generating the generated answer 50. In this way, the user may be provided a specific reference to the context source 42 used by the generative AI. Providing the source snippet 53 within the user interface 32 to the user may be at least one component of the technical solution of overcoming the technical problem of generative AI hallucination and/or overconfidence in incorrect generated answers.

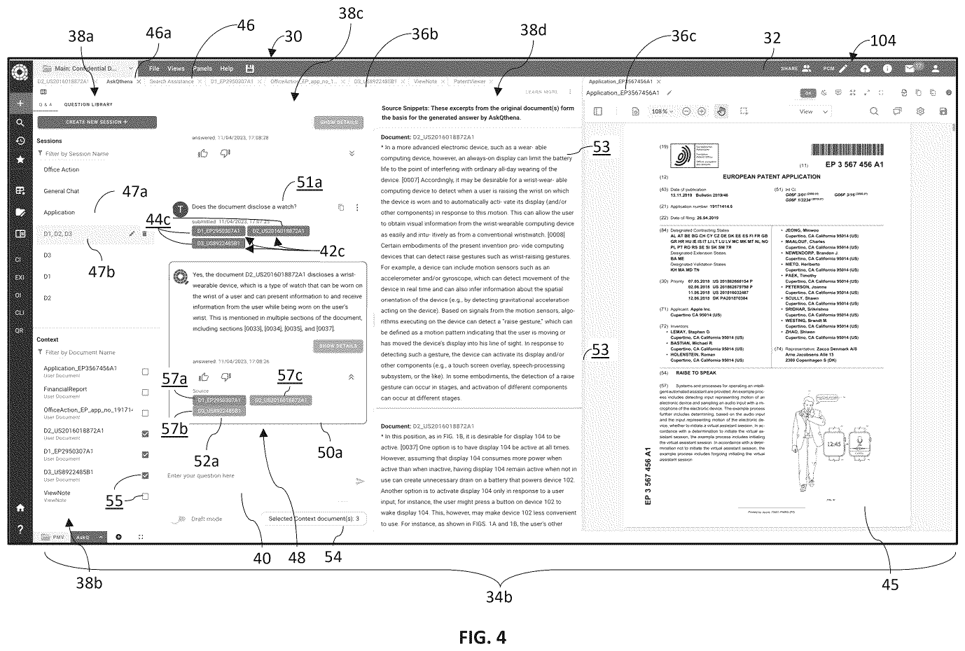

Referring now to FIG. 4, shown therein is an exemplary embodiment of a screenshot 104 of the exemplary user interface 32 for the project owner of the electronic project 30 and is configured to be edited, manipulated and/or viewed by one or more users via the computing system 10. In one embodiment, as shown in the screenshot 104, the user interface 32 has the second project view 34b and the third segment 38c as shown in FIG. 3, with the exception that in the user has asked a first question 51a, e.g., via the input box 40, against three ones of third context sources 42c as selected in the second segment 38b and as indicated by one or more third context indicator 44c. For example, as shown in FIG. 4, the user may be provided one or more check-box input 55 to select one or more document source (available context source 39a-3 through 39a-5) to be included in the generative AI context. Further, the one or more third context source 42c may be indicated in a selected context indicator 54.

In one embodiment, the first generated answer 50a and the context source information area 52a indicate that the first generated answer 50a was generated based on only two out of the selected three documents (e.g., one or more third context source 42c). Such indication may be, for example as shown in FIG. 4, by color, font properties such as size, kerning, bolding, etc., icons, and/or highlighting or the like of one or more context source indicator 57 in the context source information area 52a corresponding to whether the particular context source was used as a basis of the first generated answer 50a. As shown in FIG. 4, a first context source indicator 57a (showing text “D1_EP2950307A1”, for example) indicates that a particular one of the one or more third context source 42c was not used as a basis for the first generated answer 50a whereas a second context source indicator 57b (showing text “D2_US2016018872A1”, for example) and a third context source indicator 57c (showing text “D3_US8922485B1”, for example) indicate that one or more of the third context source 42c associated with each of the second context source indicator 57b and the third context source indicator 57c were used as a basis for the first generated answer 50a. Providing the context source indicator 57 within the user interface 32 to the user may be at least one component of the technical solution of overcoming the technical problem of generative AI hallucination and/or overconfidence in incorrect generated answers.

In one embodiment, the first segment 38a (e.g., the session management segment) stores the previously selected context for each session in a state-saved manner. As a user switches between sessions, such as first session 47a (e.g., “Application” session) of FIG. 3 and a second session 47b (e.g., “D1, D2, D3” session) of FIG. 4, the corresponding context (e.g., selected context sources within the second segment 38b, for each session 47 is automatically loaded; thereby allowing the user to continue their work from where they left off as well as reducing computing resources which would otherwise be required if the user were to re-create the context, thus, improving overall performance of the computing system 10.

In this way, the computing system 10 retains the specific context settings, including the selected source documents and any previously asked questions and answers, for each session, and is more responsive to user inputs.

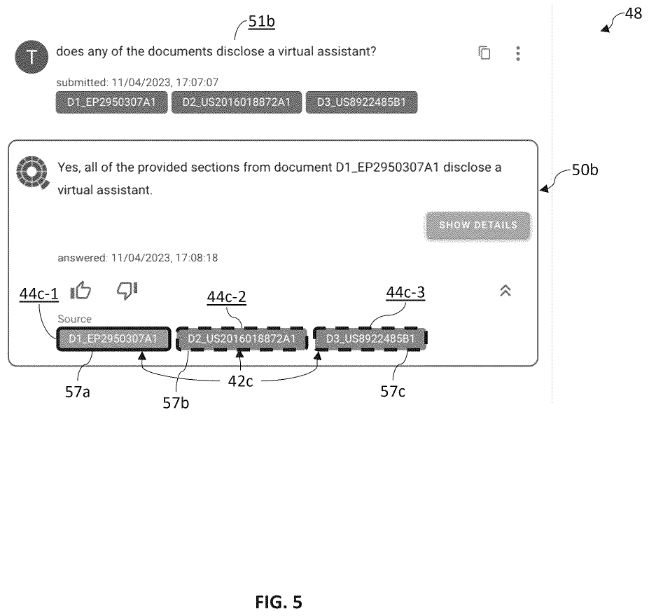

Referring now to FIG. 5, shown therein is an exemplary embodiment of a portion of the output area 48 of FIG. 4 showing a second question 51b asked in the second session 47b. FIG. 5 shows a detailed view of a second generated answer 50b having the one or more third context source 42c of FIG. 4. As shown in FIG. 5, the first context source indicator 57a (showing text “D1_EP2950307A1”, for example) indicates (for example, by coloring the first context source indicator 57a green, or, as shown in FIG. 5, by providing a solid border) that a particular one of the one or more third context source 42c (e.g., third context source 42c-1) was used as a basis for the second generated answer 50b whereas the second context source indicator 57b (showing text “D2_US2016018872A1”, for example) and the third context source indicator 57c (showing text “D3_US8922485B1”, for example) indicate (for example, by coloring each context source indicator 57 differently from the first context source indicator, or, as shown in FIG. 5, by providing a broken/dotted border) that one or more of the third context source 42c associated with each of the second context source indicator 57b (e.g., third context source 42c-2) and the third context source indicator 57c (e.g., third context source 42c-3) were not used as a basis for the second generated answer 50b. Providing the context source indicators 57 within the user interface 32 to the user may be at least one component of the technical solution of overcoming the technical problem of generative AI hallucination and/or overconfidence in incorrect generated answers, as described above.

In one embodiment, as shown in FIG. 5, text of the second generated answer 50b (“Yes, all of the provided sections from document D1_EP2950307A1 disclose a virtual assistant.”) indicates a positive response to the second question 51b as the second question 51b relates to the third context source 42c associated with the first context source indicator 57a; however, the second generated answer 50b may be silent as to whether the other third context sources 42c are also responsive to the second question 51b. It may be that one of more of the other third context sources 42c are responsive to the second question 51b, but were not used in generating the second generated answer 50b.

In one embodiment, for example a number of responsive snippets within a particular context source 42 would limit further searching in other context sources 42, the processor 12, executing the generative AI, may provide the second generated answer 50b separately for each of the third context source 42c responsive to the second question 51b (e.g., perform a one-by-one analysis for each of the third context sources 42c) and for each second generated answer 50b may provide, via the context source indicators 57, an indication of which third context source 42c is responsive to and utilized to generate that particular second generated answer 50b. In one embodiment, the processor 12 executing the generative AI may generate a set of second generated answers 50b responsive to the second question 51b for each third context source 42c and further provide a generated summary for the set of second generated answers 50b to summarize all of the second generates answers in the set.

In one embodiment, as shown in FIG. 5, text of the second generated answer 50b (“Yes, all of the provided sections from document D1_EP2950307A1 disclose a virtual assistant.”) indicates a positive response to the second question 51b. The generative AI, by anticipating a next possible question posed by the user and providing, in the second generated answer 50b, information directed to the anticipated next possible question, reduces overall compute time, and reduces a need to repeatedly process additional questions that the user is likely to ask.

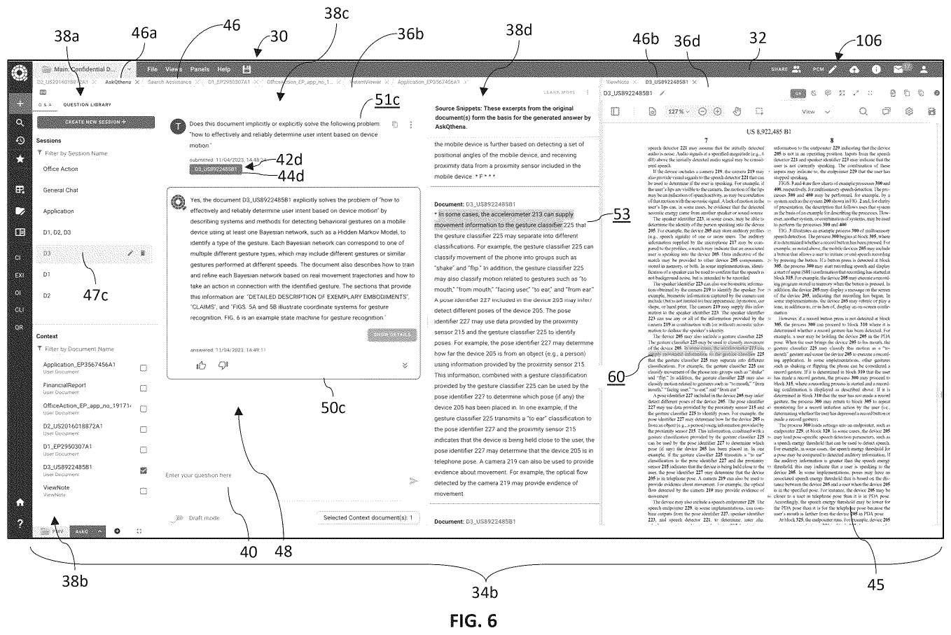

Referring now to FIG. 6, shown therein is an exemplary embodiment of a screenshot 106 of the exemplary user interface 32 for the project owner of the electronic project 30 and is configured to be edited, manipulated and/or viewed by one or more users via the computing system 10. As show in FIG. 6, the third project section 36c is “stacked” with a second tab 46b and a fourth project section 36d is shown having the source document 45 corresponding to one or more fourth context source 42d corresponding to an available context source 39a-6 in the second segment 38b as indicated by a fourth context indicator 44d. Based on user interaction with the fourth segment 38d, and a third generated answer 50c, the user can highlight the source snippet 53 in the fourth segment 38d, use by the generative AI module 24-1 to generate the third generated answer 50c. The computing system 10 may then cause a corresponding source snippet 60 of the source document 45 to highlight.

In one embodiment, the fourth segment 38d is operatively coupled to the fourth project section 36d such that the user interaction with the third segment 38c, for example, with the third generated answer 50c, causes the processor 12 to highlight the source snippet 53, utilized by the generative AI module 24-1 to generate the third generated answer 50c, as displayed within the fourth segment 38d. As shown in FIG. 6, the source document 45 is of PDF format and shows the corresponding source snippet 60 indicated (e.g., by highlighting), which corresponds to the text of the source snippet 53. While the source document 45 is shown as a PDF file, the source document could be any type of document with a written format, and may include, for example, PDF file(s), WORD file(s), EXCEL file(s), PowerPoint file(s) (WORD, EXCEL and PowerPoint are trademarks of Microsoft), text files, RTF files, source code files, and/or the like.

In the shown embodiment only a part of the source document 45 is highlighted (e.g., just the corresponding source snippet 60), while depending on user preferences, in some embodiments, the corresponding paragraph can be highlighted. This interaction between two different project sections 36 (e.g., the second project section 36b and the fourth project section 36d) provides further time savings and efficiency in the review of the user defined content, thereby reducing computing time and increasing computational efficiency.

In one embodiment, the user does not have to leave and/or navigate away from the current user interface 32 in order to: (i) input a question or instruction; (ii) define the context within which the question or instruction is executed; (iii) receive the generated answer; (iv) identify the context source 42 utilized to generate the generated answer 50; (v) retrieve and study the source snippets of the context source that was used to generate the generated answer 50; and (vi) view the source content, such as source document 45, in the original format of the source document in order to allow the user to inspect the source document itself and the document format of the source document 45, or other document properties described above.

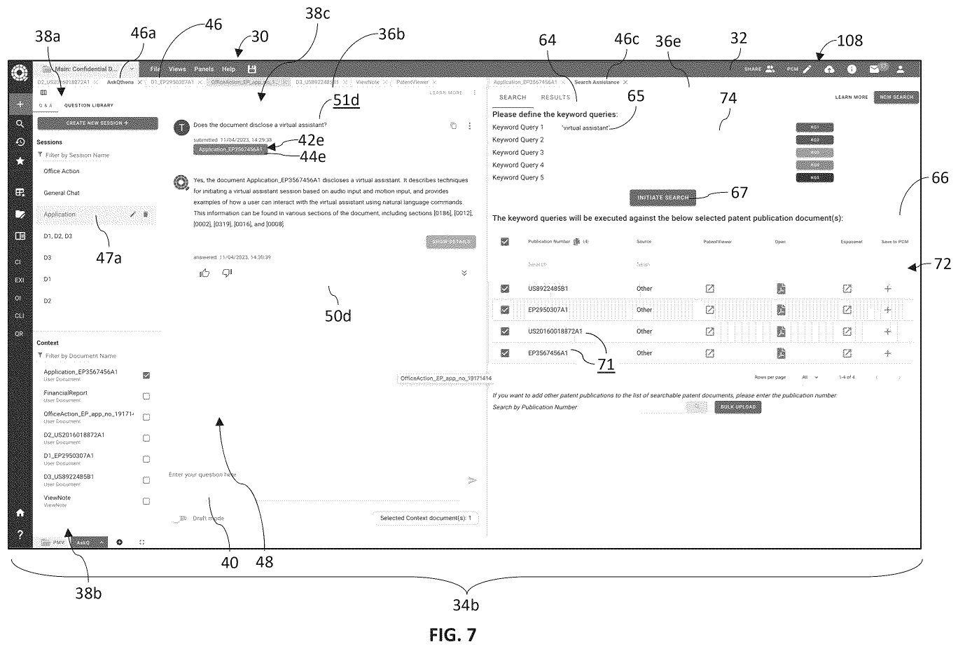

Referring now to FIG. 7, shown therein is an exemplary embodiment of a screenshot 108 of the exemplary user interface 32 for the project owner of the electronic project 30 and is configured to be edited, manipulated and/or viewed by one or more users via the computing system 10. As show in FIG. 7, a third tab 46c indicates that a fifth project section 36e is shown having a keyword pane 64 and a search list pane 66.

In one embodiment, the fifth project section 36e is operably coupled to the output area 48 of the third segment 38c such that, based on the fourth question 51d in the second project section 36b, the generative AI module 24-1 (executing on the one or more processor 12, for example) may extract one or more keyword 65 from the fourth question 51d. In one embodiment, extraction of the one or more keyword 65 may be based on one or more user-defined preference, such as extraction of technical nouns, noun chunks, or other word and/or words, for example, based on grammar classification or the like. For example, as shown in FIG. 7, the keyword 65 of “virtual assistant” is extracted and used as a search term 70 to search across one or more project document 71 associated with the electronic project 30 as shown in a project document list 72 in the search list pane 66. The one or more project document 71 may correspond with, for example, the one or more available context sources 39a.

In one embodiment, the keyword 65 may be used as the search term 70 in the keyword pane 64 as shown by search input 74 having the search term 70 populated with the keyword 65 without requiring user interaction. That is, the processor 12, executing the generative AI, pre-populates one or more search input 74 with one or more keyword 65 as the one or more search term 70.

In one embodiment, the computing system 10 may be configured to provide advanced search and filtering capabilities within the electronic project system 26, enabling users to efficiently access and utilize relevant information from the at least one database 22 and other context sources 42. By incorporating sophisticated search algorithms, natural language processing techniques, and machine learning methodologies into the generative AI module 24-1 and/or the program logic 24, the one or more processor 12 may be able to generate more accurate and relevant search results relating to the user's query (e.g., question 51) or project requirements. For instance, users can initiate search queries through the input box 40 (e.g., as one or more question 51) or by utilizing the keyword pane 64, where the processor 12 executing the generative AI module 24-1 can extract keywords 65 and provide one or more search term 70 suggestion based on the user's input. In addition, the system may offer advanced filtering options, allowing users to refine their search results based on various criteria, such as document type, date, relevance, one or more other document property, and/or another user-defined parameter, or the like. The advanced filtering options may be seamlessly integrated into the user interface 32, allowing the user to efficiently manage the information retrieval process (such as in a generated answer 50 or one or more result 77, described below) within the context scope of their electronic project 30. By providing a more streamlined and effective search experience, the computing system 10 can further enhance the overall productivity and user satisfaction while working with the electronic project system 26, thereby reducing the likelihood that the user would need to make subsequent clarifying queries—thus reducing resource demand on the processor 12, the memory 14, and/or the computing system 10.

In another embodiment, the advanced filtering options may further include an option to filter search results based on the language of the source document or one or more other document property. For example, the user may select a desired language from a list of available languages (not shown) displayed in the user interface 32, such as in the fifth project section 36e, as part of the filtering process. Additionally, the computing system 10 may provide a user with the ability to instruct the generative AI module 24-1 to create a machine translation of the source document into a target language (such as a preferred language) with a single click or user interaction received via the one or more input device 18. This streamlined translation process eliminates several steps commonly associated with translation tasks in prior art systems. By simplifying the translation process and integrating it within the advanced search and filtering capabilities provided via the user interface 32, the computing system 10 significantly increases the efficiency of the user in accessing and utilizing multilingual content, while also reducing the computing resources required to complete the task. This novel feature further enhances the overall functionality and user experience of the electronic project system 26.

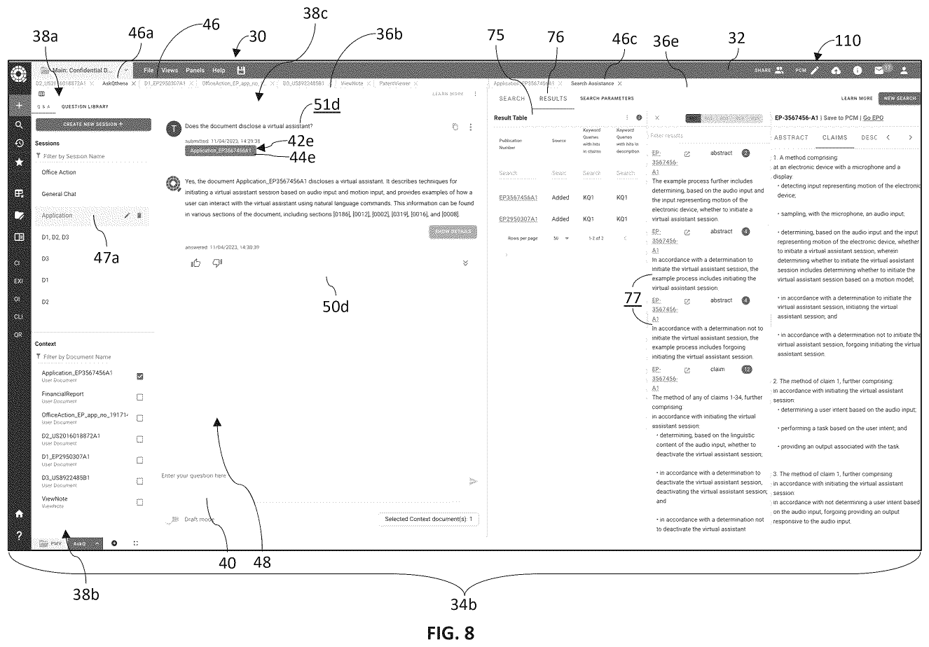

In one embodiment, after the generated answer 50d is provided in the second project section 36b of the third segment 38c on the user interface 32, the user has the option to use the generative AI module 24-1 (e.g., a natural language processor operable to provide a natural language response) or a keyword search, both in the second project view 34b. In this way, the user can easily determine of generative AI hallucination and/or overconfidence in incorrect generated answers. In one embodiment, the keyword pane 64 further includes an initiate search button 67 that when selected by the user, e.g., via at least one of the one or more input device 18, causes the processor 12 to display a results panel 75 (shown in FIG. 8).

Referring now to FIG. 8, shown therein is an exemplary embodiment of a screenshot 108 of the exemplary user interface 32 for the project owner of the electronic project 30 and is configured to be edited, manipulated and/or viewed by one or more users via the computing system 10. As show in FIG. 8, the third tab 46c indicates that the fifth project section 36e is shown having a results panel 75. The fifth project section 36e may include a results tab 76 wherein the processor 12 is operable to display the results panel 75 in the fifth project section 36e when the user selects the results tab 76, e.g., with at least one of the one or more input device 18.

As shown in FIG. 8, the results panel 75 displays one or more result 77 as a result of selecting the initiate search button 67 and based on the one or more keyword 65, e.g., “virtual assistant”. In one embodiment, the one or more result 77 may be summarized.

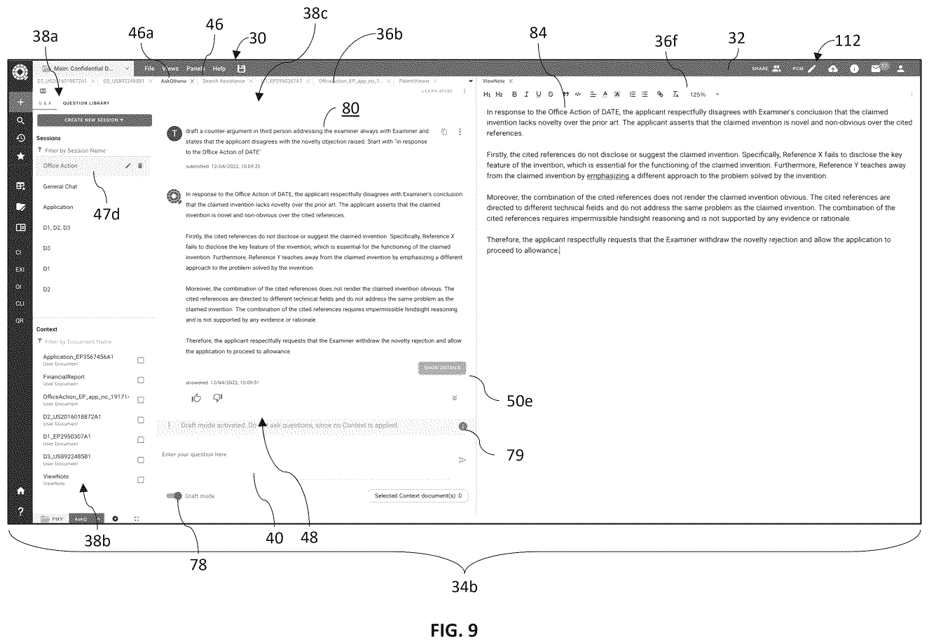

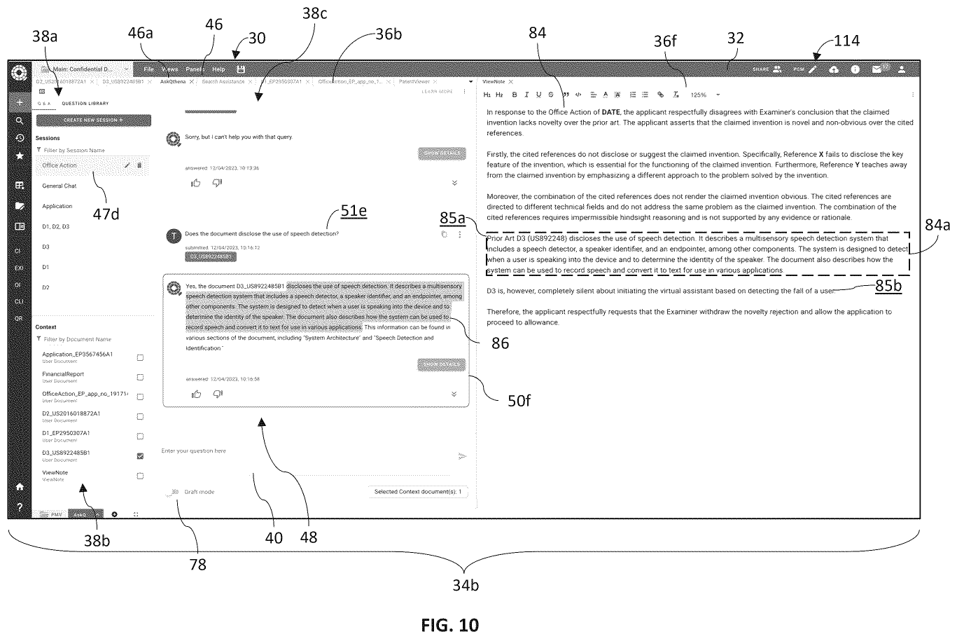

Referring now to FIG. 9 and FIG. 10 in combination, shown in FIG. 9 is an exemplary embodiment of a screenshot 112 of the exemplary user interface 32 for the project owner of the electronic project 30 and is configured to be edited, manipulated and/or viewed by one or more users via the computing system 10. As shown in FIG. 9, the second project section 36b is in a “draft mode” as indicated by a draft mode toggle 78. In one embodiment, the user, by selecting the draft mode toggle 78, may cause the processor 12 to change open a fourth tab 46d having a sixth project section 36f instantiated as a text editor project panel. In “draft mode”, the generative AI module 24-1 is no longer restricted to selected ones of the available context sources 39a, e.g., as listed in the second segment 38b. In one embodiment, one or more alert 79 may be generated by the processor 12, the one or more alert 79 being indicative of important information for consideration by the user, such as, for example, when “draft mode” is activated and warning the user that in draft mode, context is not applied.

In one embodiment, when the user enters an instruction 80 in the input box 40 and submits the instruction 80, the instruction 80 is shown in the output area 48 and the processor 12 (executing the generative AI) generates a fifth generated answer 50e, as displayed in the output area 48.

In one embodiment, the instruction 80, not necessarily being bound by context, may be more general, such as requesting that the generative AI module 24-1 draft a client letter or other content. In one embodiment, the instruction 80 may be provided by the user in a natural language format, e.g., provided as one would speak to a person.

In one embodiment, the processor 12, executing the generative AI, analyzes the instruction 80 and, based on the instruction 80, generates the fifth generated answer 50e and, in some embodiments and based on the fifth generated answer 50e, may cause the fifth project section 36e to change to, or be replaced by, a sixth project section 36f instantiated as a text editor project panel, similar in construction to the first project section 36a discussed above. In one embodiment, upon selection of text in the fifth generated answer 50e by the user, the processor 12 may cause the selected text to be inserted into the text editor of the sixth project section 36f as draft text 84. In other words, the draft text 84 may correspond to text of the fifth generated answer 50e that has been selected by the user. In some embodiments, the draft text 84 may be inserted into the sixth project section 36f upon generation of the fifth generated answer 50e.

In one embodiment, at least a portion of the draft text 84 in the sixth project section 36f may have one or more indicator that the draft text 84 was selected and/or generated by the processor 12 executing the generative AI. For example, as shown in FIG. 9, the one or more indicator may be that the draft text 84 is highlighted.

In one embodiment, shown in FIG. 10 is an exemplary embodiment of a screenshot 114 of the exemplary user interface 32 for the project owner of the electronic project 30 and is configured to be edited, manipulated and/or viewed by one or more users via the computing system 10. The draft text 84 is shown in the sixth project section 36f as further including manual text 85a and manual text 85b, for example. As shown, the manual text 85a and the manual text 85b does not include the one or more indicator because the manual text 85a and the manual text 85b was not generated by the processor 12 executing the generative AI.

In this way, the user, along with the processor 12 executing the generative AI, can draft a full letter, summary, or other kind of text draft as desired by the user.

In one embodiment, the user may de-select the draft mode toggle 78 to cause the third segment 38c to revert to a question-and-answer mode. After the user submits a fifth question 51e, and the processor 12 executing the generative AI module 24-1 generates a sixth generated answer 50f, the user may select text in the sixth generated answer 50f to be inserted into the draft text 84, e.g., as the second draft text 84a. As shown, the user may select a portion 86 of the sixth generated answer 50f as the second draft text 84a.

In one embodiment, the user may indicate a particular location within the sixth project section 36f at which the portion 86 of the sixth generated answer 50f is to be inserted, e.g., by positioning a cursor or other input device 18 at the particular location within the sixth project section 36f.

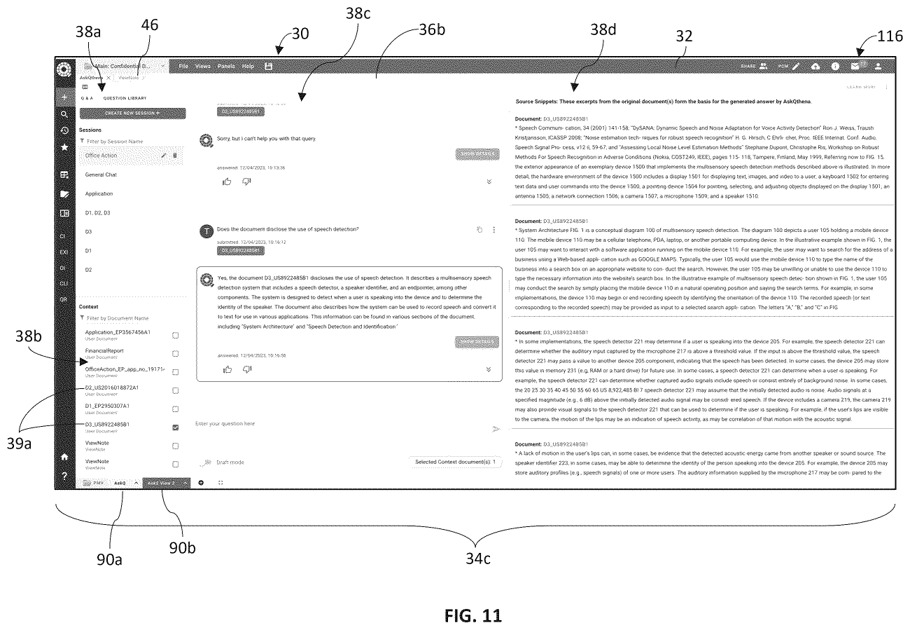

Referring now to FIG. 11, shown therein is a screenshot 116 of an exemplary user interface 32 for the project owner of the electronic project 30 and is configured to be edited, manipulated and/or viewed by one or more users via the computing system 10. The electronic project system 26 hosts the one or more electronic project 30. In one embodiment, the screenshot 116 of the electronic project 30 depicts a third project view 34c. The one or more project view 34 can display data, including but not limited to content to be reviewed, such as in one or more project section 36.

In one embodiment, the user may toggle between one or more project view 34 via interaction with one or more view tab 90. For example, as shown in FIG. 11, a first view tab 90a may cause the user interface 32 to display the second project view 34b while a second view tab 90b may cause the user interface 32 to display the third project view 34c.

In one embodiment, each project view 34 may show the same or a different of the one or more project sections 36. For example, the third project view 34c shown the second project section 36b having the third segment 38c as described above.

In one embodiment, the electronic project 30 provides the user an ability to synchronize input and output of the second project section 36b across others of the one or more project view 34, thereby increasing computational efficiency and decreasing computer load by enabling outputs from generative AI module 24-1 operations, such as generated answers 50 to be duplicated without having the generative AI module 24-1 perform duplicative computations.

In one embodiment, a further advantage may be that the second project section 36b, including the output area 48 can be arranged next to different others of the one or more project section 36 in other project views 34.

In one embodiment, each project view may comprise the second segment 38b (e.g., the context management segment 38b) displaying, and providing access to, the one or more available context sources 39a. By providing the second segment 38b with the one or more available context sources 39a between each project view 34, the processor 12 executing the generative AI module 24-1 in response to one of more question in the in the third segment 38c has access to the same available context sources 39a regardless of the project view 34, however, each project view 34 may store, e.g., in the database 22 or the memory 14, data indicative of which of the one or more available context sources 39a the user has selected in each project view 34. By providing the available context sources 39a between each project view 34, the computer system 10 does not have to process source documents for each project view 34, but instead would only process the source documents once when the source documents are first ingested into the electronic project 30. In this way, the present disclosure decreases computing demands and increases computational efficiency for the processor 12. Furthermore, the user, when interacting with the user interface 32, does not need to select a particular project view 34 to ask questions targeting a particular one or more available context source 39a because each of the one or more available context sources 39a is displayed in the second segment 38b (e.g., the context management segment) of each project view 34.

In one embodiment, the one or more electronic project 30 may selectively be shared with one or more collaborators (e.g., other users). The electronic project 30 may comprise a sharing manager interface panel with several sharing setting options that the project owner/user can select from. The user can decide to share the entire electronic project 30, i.e., the entirety of the electronic project 30 including all project views 34 that can be accessed via the one or more respective view tab 90 or by sharing one or more of the project views 34 (e.g., the second project view 34b and the third project view 34c) of the embodiment shown in FIG. 11. In one embodiment, the sharing manager may be constructed in accordance with PCT Application Number PCT/IB2022/061240 entitled “System and Method for Synchronizing Project Data” filed Nov. 21, 2022, the entire content of which is hereby incorporated herein by reference in its entirety.

In one embodiment, further project views 34 can be added, and the user can decide on the sharing rights for each of those project views 34 in a similar manner. Project views 34 that are not shared with a collaborator do not show in the user interface 32 as viewed by the collaborator. Thus, if the third project view 34c is not shared with the collaborator, then the collaborator will not have access to the third project view 34c and the second view tab 90b corresponding to the third project view 34c will not be visible or accessible. In that case, the collaborator will only see the first view tab 90a associated with the second project view 34b.

It follows from the previously discussed embodiment that the user can quickly navigate between different Q&A sessions and/or able to quickly select different context settings without requiring the processor 12 to re-compute generated answers 50 and/or re-process one or more question 51 with the generative AI, thereby increasing computational efficiency. Furthermore, providing the context sources 42, context identifiers 44, context source information areas 52, alerts 79, source snippets 53, corresponding source snippets 60, and other direct references to information relied upon by the processor 12 executing the generative AI module 24-1 may, in part, be components of the technical solution of overcoming the technical problems of generative AI hallucination and/or overconfidence in incorrect generated answers.

Furthermore, the computing system 10 provides unparalleled efficiency and trust in an AI generative system (the generative AI) because the user is, at any given point in time, in full control of the context source(s) and context setting(s) on which the generated answer 50 is based.

The embodiments showed seamless access to different sessions, thereby allowing a user to switch between these efficiently and resume the work effortlessly without undue re-computation of outputs across project sections 36 of project views 34.

In one embodiment, the session management segment stores the previously selected context for each session in a state-saved manner, such as, for example, in the at least one database 22. As a user switches between sessions, the corresponding context for each session is automatically loaded, enabling the user to continue their work from where they left off. Thus, the system retains the specific context settings, including the selected source documents and any previously asked questions and answers, for each session.

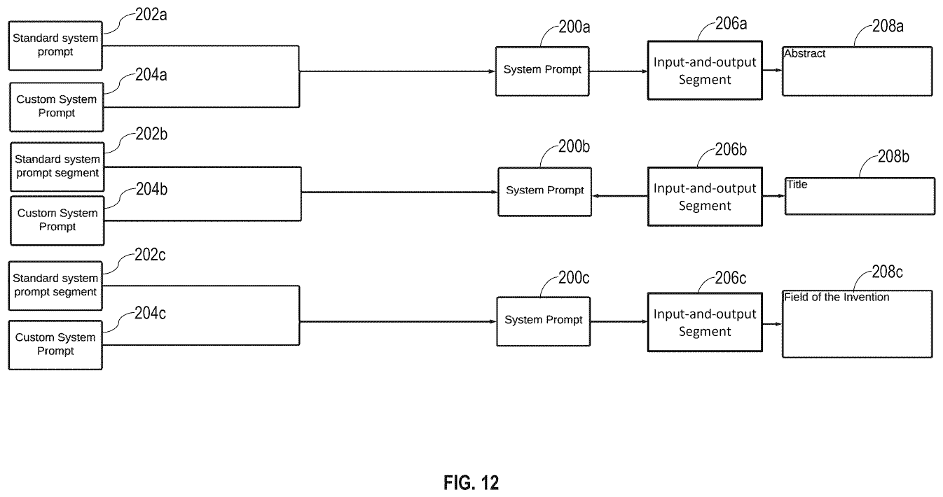

In one embodiment, the processor 12, in communication with the generative AI module 24-1, employs a system prompt. The system prompt may be customizable, or semi-customizable. Referring now to FIGS. 12-14 in combination, shown in FIG. 12 is a relationship diagram of an exemplary embodiment of one or more system prompt 200 herein described. As shown in FIG. 12, each of the one or more system prompt 200 (shown as system prompt 200a-c) comprises at least one of a standard system prompt component 202 (shown as standard system prompt component 202a-c) and a custom system prompt component 204 (shown as custom system prompt component 204a-c). The at least one of the standard system prompt component 202 and the custom system prompt component 204 may be combined to form the system prompt 200. The system prompt 200 may be used by the generative AI module 24-1 to provide background and to inform a context-aware response (e.g., generated answer 50) to one or more input component prompt 206 (e.g., at least a portion of the one or more question 51 entered into the input box 40 of the third segment 38c) when outputting a document segment 208, e.g., into the draft text 84 of a particular project section 36 instantiated as a text editor project panel. In one embodiment, if the custom system prompt component 204 and the standard system prompt component 202 have conflicting prompts, the processor 12 will prefer the standard system prompt component 202 over the custom system prompt component 204 when generating the system prompt 200.

In one embodiment, the document segment 208 may be based on a document type of a draft document 94. For example, if the draft document 94 has a document type of a patent application, the one or more document segment 208 may include an abstract segment 208a, a title segment 208b, a field of the invention segment 208c, a background segment 208d, a summary segment 208e, a brief description of the drawings segment 208f, a detailed description segment 208g, a claims segment 208h, and the like. In one embodiment, the one or more document segment 208 may be based on the Section Headers of a patent application, e.g., as provided by the United Stated Patent and Trademark Office.

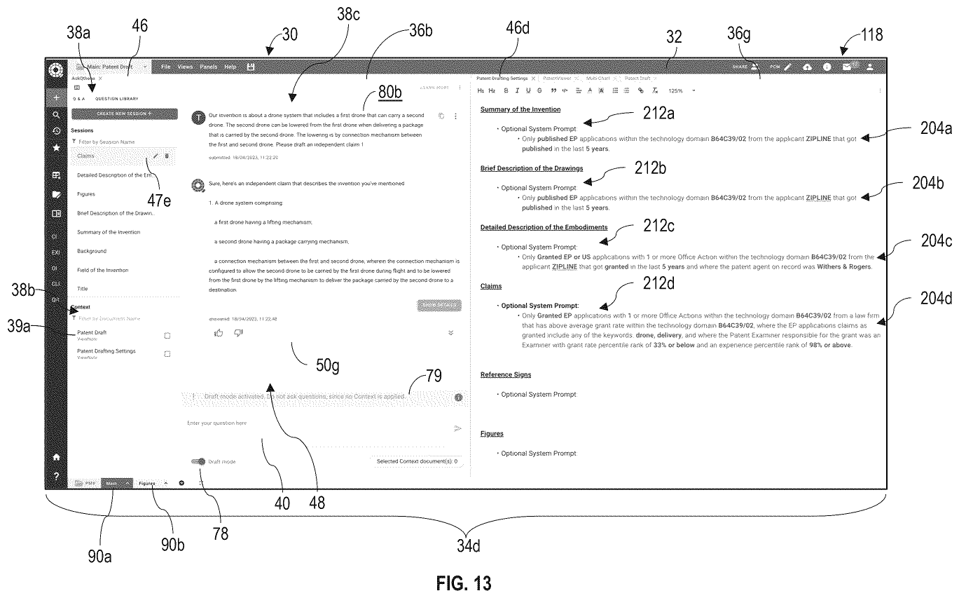

In one embodiment, the user is provided with a prompt input field (e.g., one or more prompt input 212 as shown in FIG. 13) in the user interface 32 operable to receive a user prompt as the custom system prompt component 204, as described below. In one embodiment, the custom system prompt component 204 is optional, whereas in other embodiments, the custom system prompt component 204 is required.

In one embodiment, each of the custom system prompt component 204 and standard system prompt component 202 is associated with a particular one of the document segment 208. In embodiment, the document segment 208 may correspond to, or be associated with, a particular element of a draft document (e.g., an abstract element, or field of the invention element”) or a particular document type, e.g., a draft patent application, a draft office action response, or other document type, which may, in some embodiments, correspond to one or more mode setting.

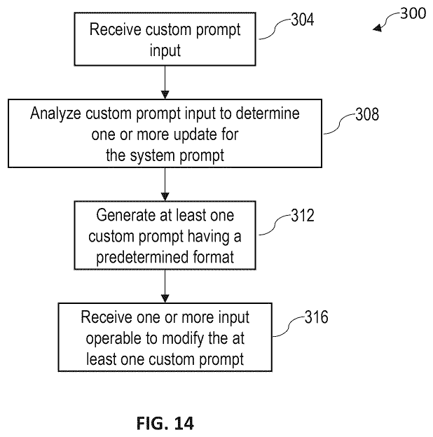

In one embodiment, the single user interface 32 has one or more mode setting. The mode setting may affect which of the custom system prompt component 204 is combined with the standard system prompt component 202 to generate the system prompt 200 (e.g., as described below in relation to FIG. 14). In this manner, the mode setting may determine which custom system prompt component 204, if any, is combined with the standard system prompt component 202 to generate the system prompt 200.

In one embodiment, the one or more mode setting may be a mode setting corresponding to a document type, for example. Exemplary mode settings may include, for example, “patent drafting mode”, “office action reply mode”, “client report letter mode”, “patent claim chart mode”, “financial annual report mode”, “tax report mode”, “invention disclosure mode”, “patent search report mode”, “trademark search report mode”, “IP clearance report mode”, “litigation brief mode”, “Notice of patent opposition mode”, “notice of patent appeal mode”, “IPR brief mode”, “IPR response mode”, “Appeal Brief mode”, “final office action response mode”, and/or the like, or some combination thereof.

For example, assume the mode setting of the single user interface 32 is set to “Patent draft mode” and the user provides an instruction 80 of “Include insights from applications of law firm Dunlap Codding that were published in the last 5 years within IPC A61K.” The processor 12, in communication with the generative AI module 24-1, may retrieve 100 claims of the most recent applications drafted by Dunlap Codding in the specified IPC of A61K to include in the custom system prompt component 204 when working in the document segment corresponding to the claims segment. However, if the mode setting of the single user interface 32 is set to “office action reply mode”, the custom system prompt component 204 may include 100 most recent arguments submitted by Dunlap Codding on the rejections within the Office Action (e.g., regarding novelty or non-obviousness) across, optionally only, previously granted patents.

Referring now to FIG. 13, shown therein is a screenshot 118 of an exemplary user interface 32 for the project owner of the electronic project 30 and is configured to be edited, manipulated and/or viewed by one or more users via the computing system 10. The electronic project system 26 hosts the one or more electronic project 30. In one embodiment, the screenshot 118 of the electronic project 30 depicts the fourth project view 34d. The one or more project view 34 can display data, including but not limited to content to be reviewed, such as in one or more project section 36, e.g., a seventh project section 36g providing the prompt input field (e.g., the one or more prompt input 212) operable to receive the user prompt. In one embodiment, the user prompt is converted into the custom system prompt component 204 whereas in another embodiment, the user prompt is used as the custom system prompt component 204.

In one embodiment, as shown in FIG. 13, for example, the user is provided with the prompt input field via the seventh project section 36g as indicated by a fourth tab 46d. The seventh project section 36g may provide one or more prompt inputs 212a-d operable to receive a custom prompt input from the user, e.g., the user prompt. The user may provide the custom prompt input, via the one or more input device 18, which in turn is associated with one or more of the custom system prompt component 204, e.g., as described below in reference to FIG. 14.

In one embodiment, the user is provided with the prompt input field via one or more guided prompt generator displayed on the user interface 32. For example, the custom system prompt component 204a provides “Only PUBLISHED EP applications within the technology domain B64C39/02 from the applicant ZIPLINE that got PUBLISHED in the last 5 years,” where each ‘bold’ word/phrase may be selected from a predetermined list of options. For example, if the user were to select, e.g., via the one or more input device 18, “PUBLISHED”, the user may be provided with one or more other options, for example, a drop-down list further including “GRANTED”; or if the user were to select “EP” the user may be provided with one or more other option, for example, “US”, “GB”, or any other country code, or the like. In this way, the inputs from the user may be formed by the one or more guided prompt generator to conform to a predetermined data-structure type, which may be stored, for example, in the database 22 and/or in the memory 14.

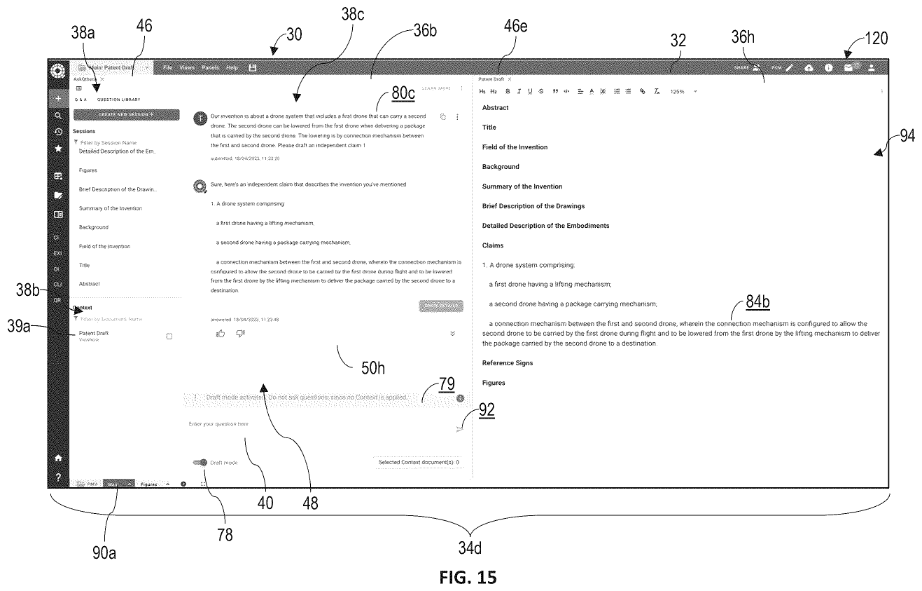

As shown in FIG. 13, and further detailed in FIG. 15, a second instruction 80b has been submitted, e.g., via the input box 40 as described above, to the output area 48, thereby resulting in a seventh generated answer 50g being generated by the processor 12 in communication with the generative AI module 24-1.

In one embodiment, the standard system prompt component 202 and the custom system prompt component 204 are integrated with the one or more input component prompt 206 to generate the system prompt 200. For example, if the user selects custom prompt component 204d, the user may be presented with a number of claims matching the custom prompt component 204d of which the user may select 10 claims which the user prefers. The 10 claims which the user prefers may form at least a part of the custom system prompt component 204. Additionally, the custom system prompt component 204 and/or the one or more input component prompt 206 may include one or more user instruction previously provided via the user interface 32, for example.

In one embodiment, the standard system prompt component 202 may comprise one or more instruction header having one or more instruction (such as the one or more user instruction and/or one or more system instruction). For example, the standard system prompt component 202 may comprise a first instruction header such as “When you draft claims, consider the following claim wording and terminology as examples preferred by the user:” with one or more user instruction comprising the selected 10 preferred claims. Additionally, the standard system prompt component 202 may comprise a second instruction header such as “However, irrespective of user preference, when you draft patent claims, do adhere to the following general drafting rules first and foremost for the currently selected domain B64C39/02 to achieve a higher quality patent claim:” with one or more system instruction such as “Use Unmanned Aerial Vehicle and not Drone”, for example. In one embodiment, the one or more instruction header may have one or more user instruction and one or more system instruction.

In one embodiment, the one or more system instruction is not viewable and/or editable by the user. In this way, system instructions may be provided to correct for claim drafting issues that may be introduced, either intentionally or unintentionally, by the one or more user instructions and/or one or more user preferences.

In one embodiment, the one or more user instruction may be generated, e.g., by the generative AI module 24-1, based on the instruction 80, such as the second instruction 80b. For example, a user instruction of “Use Connection mechanism and not Connector”, may be generated by the generative AI module 24-1 from a portion of the instruction 80 stating “Use a more technical term for ‘connector’.” In one embodiment, the user may be provided with the user instruction as generated by the generative AI module 24-1, whereas in other embodiments, the user is not provided with the user instruction generated by the generative AI module 24-1.

Referring now to FIG. 14, shown therein is a process flow diagram of an exemplary embodiment of a prompt generation process 300 constructed in accordance with the present disclosure. The prompt generation process 300 generally comprises the steps of: receiving the custom prompt input (step 304); analyzing the custom system prompt input to determine one or more change for the system prompt (step 308); generating at least one custom prompt having a predetermined format (step 312); and receiving one or more input operable to modify the at least one custom prompt (step 316). Generally, the steps of the prompt generation process 300 may be stored as processor-executable code in the memory 14 and may be executed by the processor 12 (e.g., or by the processor 12-1 as detailed above).

In one embodiment, receiving the custom prompt input (step 304) comprises retrieving, e.g., by the one or more processor 12, the custom prompt input from the one or more prompt input 212, e.g., as displayed on the user interface 32, the custom prompt input being one or more of a voice input, text input, interaction input, or any other input as received by the processor 12 via the one or more input device 18. In one embodiment, the custom prompt input is received in natural language format.

In one embodiment, receiving the custom prompt input (step 304) further comprises displaying on the user interface 32 one or more guided prompt generator operable to receive one or more input from the user to select one or more prompt element of the custom prompt input from a predetermined list of prompt elements.

In one embodiment, receiving the custom prompt input (step 304) further comprises receiving one or more input from the user based on one or more filter parameter, such as constructed in accordance with the keyword pane 64. In one embodiment, the keyword pane 64 may be modified to operate in accordance with the guided prompt generator.

In one embodiment, analyzing the custom system prompt input to determine one or more update for the system prompt (step 308) comprises analyzing the custom prompt input to determine if one or more update, change, and/or modification of the standard system prompt component 202 should be made, and, if so, update the standard system prompt component 202. In one embodiment, the user is not made aware of the standard system prompt component 202, e.g., the standard system prompt component 202 is kept private from the user.

In one embodiment, if the user indicates in the custom prompt input that the user desires a particular document segment 208 to be drafted, the one or more processor 12 may update the standard system prompt component 202 to include one or more predetermined aspect related to the particular document segment 208 based on the custom prompt input. For example, if the user indicates in the custom prompt input that the user is drafting a patent, the standard system prompt component 202 may be updated to include one or more prompt aspect such as patent examiner, IPC classification, CPC classification, keywords of the description, keywords of the claims, characteristics of the examiner, characteristics of the art unit, characteristics of the examining division, case law cited during prosecution of an application, opposition procedure of an application, appeal procedure of an application, grant rate of the examiner, grant rate of the art unit, grant rate of the examining division, experience level of the examiner, experience level of the applicant, experience level of the patent attorney/agent, experience level of the law form, and/or the like, or some combination thereof. In one embodiment, the one or more prompt aspect may further include specific previous cases of a particular examiner, and/or specific previous cases of a particular applicant and/or agent, e.g., only cases of a particular law firm that include clarity objections and extended subject matter objections, and/or the like, or some combination thereof.

In one embodiment, generating at least one custom prompt having a predetermined format (step 312) comprises modifying the custom prompt input to format the custom prompt input into at least one custom prompt. For example, one or more word may be added or removed from the custom prompt input to generate the at least one custom prompt.

In one embodiment, generating at least one custom prompt having a predetermined format (step 312) includes retrieving by the processor 12 one or more text snippet, e.g., from the database 22, based on the custom prompt input. The One or more text snippet may be related to the one or more prompt aspect as described above.

In one embodiment, generating at least one custom prompt having a predetermined format (step 312) may include generating the at least one custom prompt in consideration of the prompt aspects identified by the user. In one embodiment, the user may identify the one or more prompt aspect in user preferences, for example, based on a document type, or a document segment 208. In one embodiment, generating at least one custom prompt having a predetermined format (step 312) based on the at least one prompt aspect provides for tailored guidance from the generative AI module 24-1 as the user is drafting the document (as shown below).

In one embodiment, generating at least one custom prompt having a predetermined format (step 312) includes generating more than one custom prompt having a predetermined format. For example, the processor 12 may generate a first custom prompt of “Consider addressing the Examiner's concerns regarding inventive step based on the Examiner's past objections”, a second custom prompt of “Include specific IPC/CPC classifications that are relevant to the invention”, a third custom prompt of “Add keywords from the description to strengthen the claims”, a fourth custom prompt of “Refer to relevant case law cited during the prosecution to support your arguments”, a fifth custom prompt of “Address the Examiner's grant rate and experience level to tailor your response effectively”, and/or the like, or some combination thereof. In one embodiment, receiving one or more input operable to modify the at least one custom prompt (step 316) includes displaying each custom prompt on the single user interface 32 and receiving, by the processor 12, one or more input responsive to user interaction with the one or more input devices 18 and indicative of a selection of a particular one of the displayed custom prompts. The selected custom prompt may then be utilized as the custom system prompt component 204 in generating the system prompt 200.

In one embodiment, receiving one or more input operable to modify the at least one custom prompt (step 316) includes displaying the at least one custom prompt having the predetermined format on the single user interface 32 and receiving, by the processor 12, one or more input responsive to user interaction with the one or more input devices 18 and indicative of a modification to the at least one custom prompt. For example, if the user provides a custom prompt input of “Consider most recent 10 independent claims allowed in this art unit”, the processor 12 may determine the most recent 10 independent claims allowed in a particular art unit, further based on the user preference of the one or more prompt aspect, such that, for example, the most recent 10 independent claims allowed in the particular art unit may further be filtered by only looking at claims where at least one Office Action has been issued or that have been written by an attorney with a high rate of claims allowed and/or upheld in IRP or litigation. In turn, these “most recent 10 independent claims” may be provided to the user via the single user interface 32 and allow the user to provide one or more input, such as to remove or modify any of the “most recent 10 independent claims” before the “most recent 10 independent claims” are provided as the at least one custom prompt to the custom system prompt component 204 used in generating the system prompt 200.

Referring now to FIG. 15, shown therein is an exemplary embodiment of a screenshot 120 of the exemplary user interface 32 for the project owner of the electronic project 30 and is configured to be edited, manipulated and/or viewed by one or more users via the computing system 10. In one embodiment, the screenshot 120 of the electronic project 30 depicts a fourth project view 34d. As shown in FIG. 15, the second project section 36b is in a “draft mode”, e.g., indicative by selection of the draft mode toggle 78 and/or a fifth tab 46e. In one embodiment, the user, by selecting the draft mode toggle 78, may cause the processor 12 to instantiate an eighth project section 36h as a text editor project panel, similar in construction to the sixth project section 36f, having a draft document 94. In “draft mode”, the generative AI module 24-1 is not restricted to context sources, e.g., as listed in the second segment 38b. In one embodiment, one or more alert 79 may be generated by the processor 12, the one or more alert 79 being indicative of important information for consideration by the user, such as, for example, when “draft mode” is activated and warning the user that in draft mode the one or more context source is not applied.

In one embodiment, when the user enters a third instruction 80c in the input box 40 and submits the third instruction 80c, the third instruction 80c is shown in the output area 48 and the processor 12 (in communication with and/or executing the generative AI module 24-1) generates an eighth generated answer 50h, as displayed in the output area 48.

In one embodiment, the third instruction 80c, not necessarily being bound by context sources, may be more general, such as requesting that the generative AI module 24-1 draft a document segment 208, e.g., draft claims for a patent application. In one embodiment, the third instruction 80c may be provided by the user in a natural language format, e.g., provided as one would speak to a person.

In one embodiment, when the user selects submit button 92 in the user interface 32, the third instruction 80c is received by the processor 12 (e.g., as the one or more input component prompt 206). The processor 12, in communication with (e.g., executing) the generative AI module 24-1, generates the eighth generated answer 50h in consideration of the system prompt 200, that is, a combination of the standard system prompt component 202, the custom system prompt component 204, and the input component prompt 206.

In one embodiment, the processor 12, in communication with (e.g., executing) the generative AI module 24-1, analyzes the third instruction 80c and, based on the third instruction 80c and the system prompt 200 associated with that particular document segment 208, e.g., claims segment, generates the eighth generated answer 50h and, in some embodiments and based on the eighth generated answer 50h, may cause the processor 12 to instantiate the eighth project section 36h in the single user interface 32, as the text editor project panel, similar in construction to the first project section 36a discussed above. In one embodiment, upon selection of text in the eighth generated answer 50h by the user, the processor 12 may cause the selected text to be inserted into the text editor of the eighth project section 36h as a draft text 84b. In other words, the draft text 84b may correspond to text of the eighth generated answer 50h that has been selected by the user. In some embodiments, the draft text 84b may be inserted into the eighth project section 36h upon generation of the eighth generated answer 50h.

In one embodiment, at least a portion of the draft text 84b in the eighth project section 36h may have one or more indicator that the draft text 84b was selected and/or generated by the processor 12 in communication with the generative AI module 24-1. For example, as shown in FIG. 15, the one or more indicator may be that the draft text 84b is highlighted.

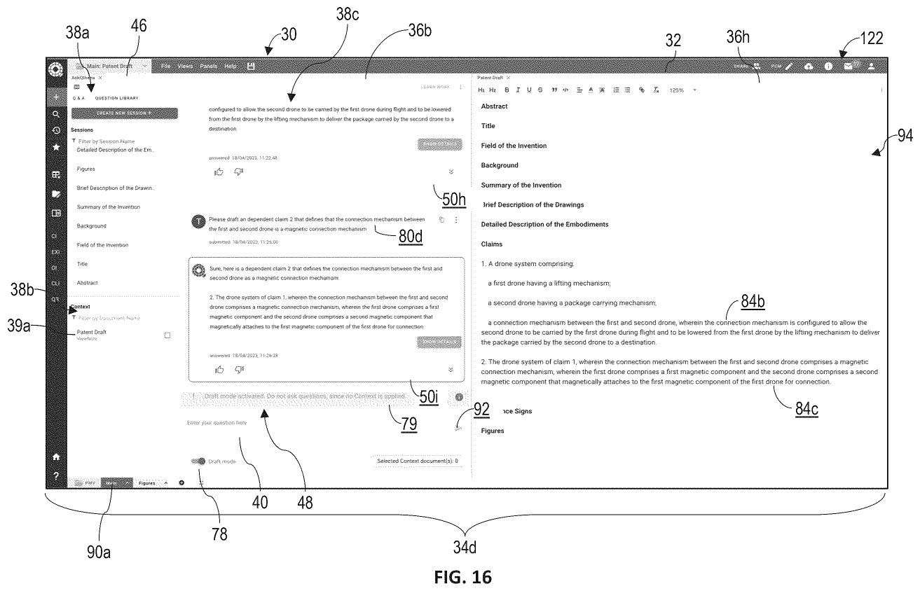

Referring now to FIG. 16, shown therein is an exemplary embodiment of a screenshot 122 of the exemplary user interface 32 for the project owner of the electronic project 30 and is configured to be edited, manipulated and/or viewed by one or more users via the computing system 10. The screenshot 122, as shown, follows from the screenshot 120 wherein the user has provided a further instruction 80, shown as a fourth instruction 80d.

In one embodiment, when the user selects submit button 92 in the user interface 32, the fourth instruction 80d is received by the processor 12 (e.g., the one or more input component prompt 206). The processor 12, in communication with the generative AI module 24-1, generates a nineth generated answer 50i in consideration of the system prompt 200, that is, a combination of the standard system prompt component 202 and the custom system prompt component 204, as well as in consideration of the one or more input component prompt 206.

In one embodiment, the processor 12, in communication with the generative AI module 24-1, analyzes the fourth instruction 80d and, based on the fourth instruction 80d and the system prompt 200 associated with that particular document segment 208, e.g., claims segment, generates the nineth generated answer 50i and, in some embodiments and based on the nineth generated answer 50i, may cause the processor 12 to instantiate the eighth project section 36h in the single user interface 32, as the text editor project panel, similar in construction to the first project section 36a discussed above.

In one embodiment, upon selection of text in the nineth generated answer 50i by the user, the processor 12 may cause the selected text to be inserted into the text editor of the eighth project section 36h as a draft text 84c in addition to the prior-inserted draft text 84b, for example. In other words, the draft text 84c may correspond to text of the nineth generated answer 50i that has been selected by the user. In some embodiments, the draft text 84c may be inserted into the eighth project section 36h upon generation of the nineth generated answer 50i. In one embodiment, the processor 12 may determine a particular location within the draft document to insert the draft text 84c. For example, the user providing the fourth instruction 80d including an instruction to generate a second claim may cause the processor 12 to generate a second claim and automatically insert the second claim after a first claim in the draft document 94. Further, the user providing another instruction including an instruction to insert a new second claim may cause the processor 12 to generate a new second claim and insert the new second claim after the first claim, as well as cause the processor 12 to automatically renumber the prior-drafted second claim as a third claim and update dependencies and antecedents as needed.

In one embodiment, the user may indicate, via the user interface 32, a particular location within the eighth project section 36h at which the nineth generated answer 50i, or, for example, a portion 86 thereof, is to be inserted, e.g., by positioning a cursor or other of the one or more input device 18 at the particular location within the eighth project section 36h.

In one embodiment, at least a portion of the draft text 84c in the eighth project section 36h may have one or more indicator that the draft text 84c was selected and/or generated by the processor 12 in communication with the generative AI module 24-1. For example, as shown in FIG. 16, the one or more indicator may be that the draft text 84c is highlighted.

It should be noted that, while not shown in FIG. 16, the user may provide manual text 85 in the eighth project section 36h. In one embodiment, if the user provides manual text 85 in the eighth project section 36h to modify or alter previously inserted draft text 84, such as the draft text 84b, the processor 12 may further consider the one or more manual text 85 to the draft text 84b when the processor 12, in communication with the generative AI module 24-1, generates the draft text 84c, for example.

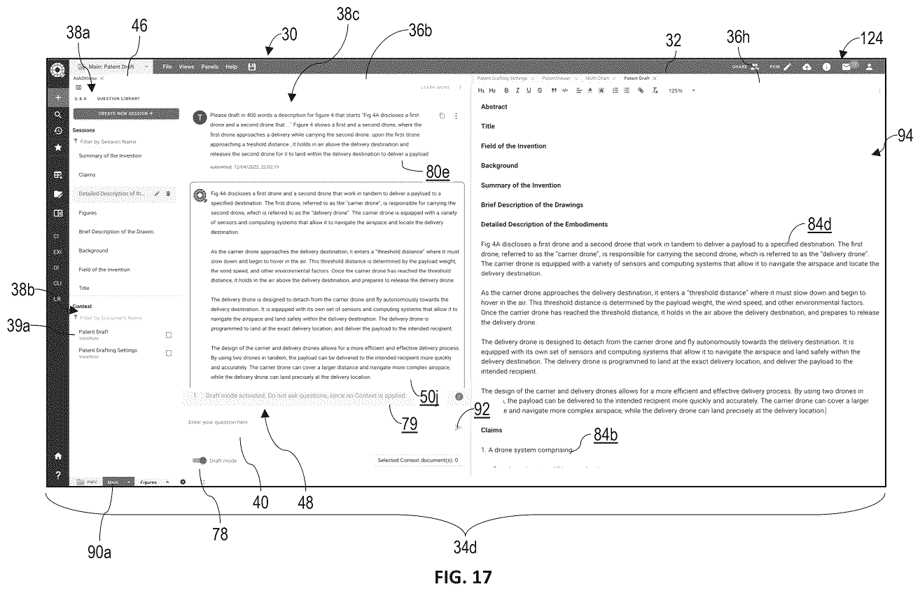

Referring now to FIG. 17, shown therein is an exemplary embodiment of a screenshot 124 of the exemplary user interface 32 for the project owner of the electronic project 30 and is configured to be edited, manipulated and/or viewed by one or more users via the computing system 10. The screenshot 124, as shown, follows from the screenshot 122 wherein the user has provided a further instruction 80, shown as a fifth instruction 80e.

In one embodiment, when the user selects submit button 92 in the user interface 32, the fifth instruction 80e is received by the processor 12 (e.g., the one or more input component prompt 206). The processor 12, in communication with the generative AI module 24-1, generates a tenth generated answer 50j in consideration of the system prompt 200, that is, a combination of the standard system prompt component 202 and the custom system prompt component 204, as well as in consideration of the one or more input component prompt 206.

In one embodiment, the processor 12, in communication with the generative AI module 24-1, analyzes the fifth instruction 80e and, based on the fifth instruction 80e and the system prompt 200 associated with that particular document segment 208, e.g., detailed description segment, generates the tenth generated answer 50j and, in some embodiments and based on the tenth generated answer 50j, may cause the processor 12 to instantiate the eighth project section 36h in the user interface 32, as the text editor project panel, similar in construction to the first project section 36a discussed above.

In one embodiment, upon selection of text in the tenth generated answer 50j by the user, the processor 12 may cause the selected text to be inserted into the text editor of the eighth project section 36h as a draft text 84d in addition to the prior-inserted draft text 84b and draft text 84c, for example. In other words, the draft text 84d may correspond to text of the tenth generated answer 50j that has been selected by the user. In some embodiments, the draft text 84d may be inserted into the eighth project section 36h upon generation of the tenth generated answer 50j.

In one embodiment, the processor 12 may determine a particular location within the draft document to insert the draft text 84d. For example, the user providing the fifth instruction 80e including an instruction to generate a “description of FIG. 4A” may cause the processor 12 to generate the description of FIG. 4A and automatically insert the description of FIG. 4A in the draft document 94 within the Detailed Description of the Embodiments section 208g. Further, the user providing another instruction including an instruction to insert a “description of FIG. 4B” may cause the processor 12 to generate a description of FIG. 4B and insert the description of FIG. 4B after the description of FIG. 4A, as well as cause the processor 12 to automatically insert part numbers or update part numbers as needed.

In one embodiment, the user may indicate a particular location within the eighth project section 36h at which the tenth generated answer 50j, or, for example, a portion 86 thereof, is to be inserted as the draft text 84d, e.g., by positioning a cursor or other of the one or more input device 18 at the particular location within the eighth project section 36h.

In one embodiment, at least a portion of the draft text 84d in the eighth project section 36h may have one or more indicator that the draft text 84d was selected and/or generated by the processor 12 in communication with the generative AI module 24-1. For example, as shown in FIG. 17, the one or more indicator may be that the draft text 84d is highlighted.

It should be noted that, while not shown in FIG. 17, the user may provide manual text 85 in the eighth project section 36h. In one embodiment, if the user provides manual text 85 in the eighth project section 36h to modify or alter previously inserted draft text 84, such as the draft text 84d, the processor 12 may further consider the one or more manual text 85 to the draft text 84d when the processor 12, in communication with the generative AI module 24-1, generates additional draft text 84. For example, if the processor 12 in communication with (e.g., executing) the generative AI module 24-1, generates a first part name for a particular element of a figure, and the user updated the first part name to a second part name for that particular element, the processor 12 when generating further draft text 84, may utilize the same second part name for the particular element.

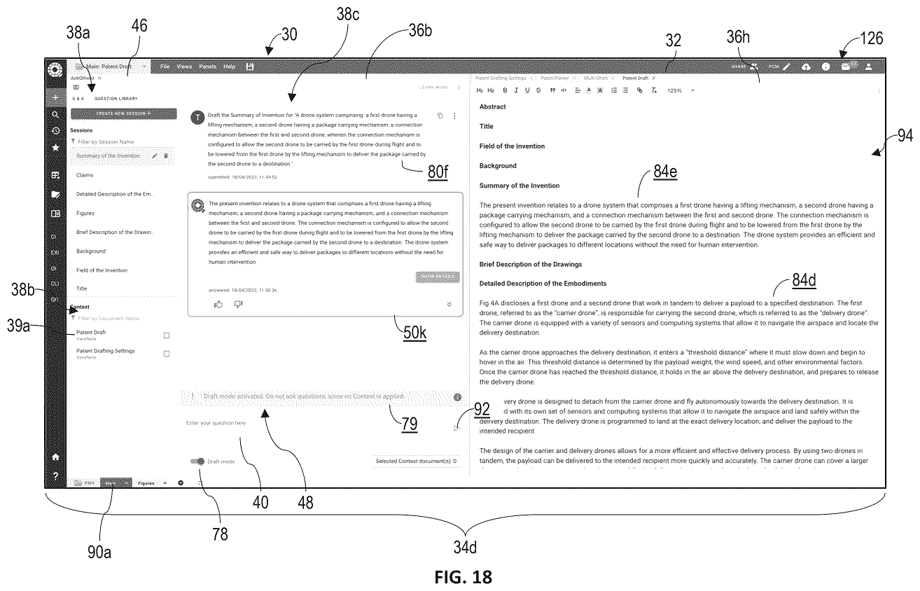

Referring now to FIG. 18, shown therein is an exemplary embodiment of a screenshot 126 of the exemplary user interface 32 for the project owner of the electronic project 30 and is configured to be edited, manipulated and/or viewed by one or more users via the computing system 10. The screenshot 126, as shown, follows from the screenshot 124 wherein the user has provided a further instruction 80, shown as a sixth instruction 80f.

In one embodiment, when the user selects submit button 92 in the user interface 32, the sixth instruction 80f is received by the processor 12 (e.g., the one or more input component prompt 206). The processor 12, in communication with the generative AI module 24-1, generates an eleventh generated answer 50k in consideration of the system prompt 200, that is, a combination of the standard system prompt component 202 and the custom system prompt component 204.

In one embodiment, the processor 12, in communication with the generative AI module 24-1, analyzes the sixth instruction 80f and, based on the sixth instruction 80f and the system prompt 200 associated with that particular document segment 208, e.g., the summary of the invention segment, generates the eleventh generated answer 50k and, in some embodiments and based on the eleventh generated answer 50k, may cause the processor 12 to instantiate the eighth project section 36h in the user interface 32, as the text editor project panel, similar in construction to the first project section 36a discussed above.

In one embodiment, upon selection of text in the eleventh generated answer 50k by the user, the processor 12 may cause the selected text to be inserted into the text editor of the eighth project section 36h as a draft text 84e in addition to the prior-inserted draft text 84b, draft text 84c, and draft text 84d, for example. In other words, the draft text 84e may correspond to text of the eleventh generated answer 50k that has been selected by the user. In some embodiments, the draft text 84e may be inserted into the eighth project section 36h upon generation of the eleventh generated answer 50k.

In one embodiment, the processor 12 may determine a particular location within the draft document to insert the draft text 84e. For example, the user providing the sixth instruction 80f including an instruction to generate a “summary of the invention” may cause the processor 12 to generate the summary of the invention and automatically insert the summary of the invention in the draft document 94 within the summary segment 208e.

In one embodiment, the user may indicate a particular location within the eighth project section 36h at which the eleventh generated answer 50k, or, for example, a portion 86 thereof, is to be inserted as the draft text 84e, e.g., by positioning a cursor or other of the one or more input device 18 at the particular location within the eighth project section 36h.

In one embodiment, at least a portion of the draft text 84e in the eighth project section 36h may have one or more indicator that the draft text 84e was selected and/or generated by the processor 12 in communication with the generative AI module 24-1. For example, as shown in FIG. 18, the one or more indicator may be that the draft text 84e is highlighted.

It should be noted that, while not shown in FIG. 18, the user may provide manual text 85 in the eighth project section 36h. In one embodiment, if the user provides manual text 85 in the eighth project section 36h to modify or alter previously inserted draft text 84, such as the draft text 84e, the processor 12 may further consider the one or more manual text 85 to the draft text 84e when the processor 12, in communication with the generative AI module 24-1, generates additional draft text 84. For example, if the processor 12 in communication with the generative AI module 24-1, generates a first part name for a particular element of a figure, and the user updated the first part name to a second part name for that particular element, the processor 12 when generating further draft text 84, may utilize the same second part name for the particular element. In one embodiment, when the user provides the one or more manual text 85, the processor 12 may cause to be displayed on the user interface 32 one or more confirmation that the user intends to change the part name and/or one or more query whether the user would like to make similar changes through the draft document 94. If the user answers in the affirmative to the query, the processor 12, in communication with the generative AI module 24-1, may cause the part name to be updated from the first part name to the second part name as well as updating similar part name(s) in the draft document 94. For example, if the user inserts manual text 85 changing a draft text of “the motor widget 10 includes a motor sprocket 12” to “the engine widget 10 includes a motor sprocket 12”, the processor 12, in communication with the generative AI module 24-1, may additionally change “motor sprocket 12” to “engine sprocket 12” if the user answers in the affirmative to the query.

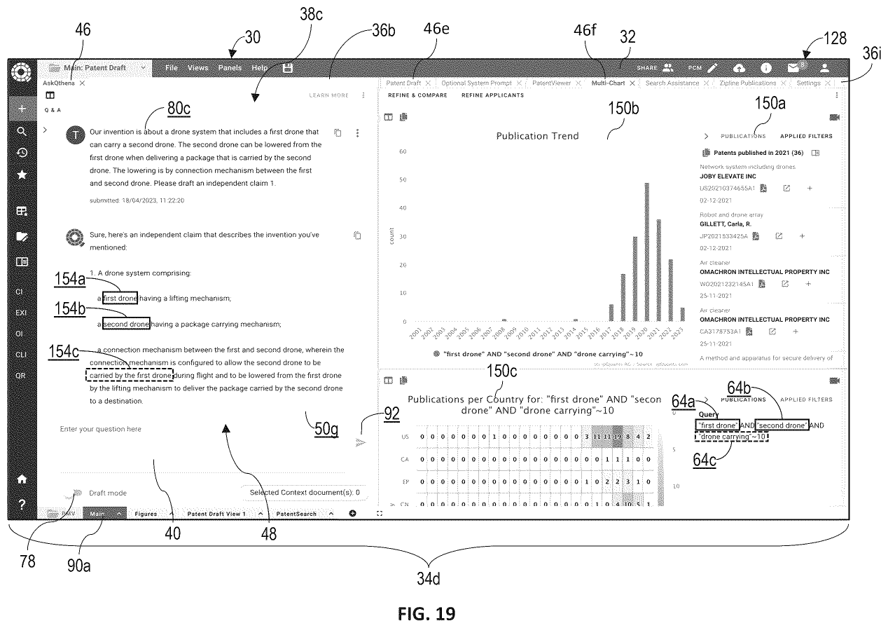

Referring now to FIG. 19, in combination with FIG. 7 and FIG. 15, shown therein is an exemplary embodiment of a screenshot 128 of the exemplary user interface 32 for the project owner of the electronic project 30 and is configured to be edited, manipulated and/or viewed by one or more users via the computing system 10. As shown in FIG. 19, a sixth tab 46f indicates that a nineth project section 36i is shown as a landscape dashboard panel having one or more dashboard element 150. In one embodiment, the one or more dashboard element 150 may be a bar chart, line chart, pie chart, density map, scatter plot, Gantt chart, treemap, one or more graph (such as a bar graph, line graph, etc.), a mosaic chart, a radar chart, hierarchy diagram, decision diagram, multi-level pie chart, 3D charts, 3D graphs, and/or the like, or some combination thereof.

In one embodiment, when the user selects submit button 92 in the user interface 32, the third instruction 80c is received by the processor 12 (e.g., the one or more input component prompt 206). The processor 12, in communication with the generative AI module 24-1, generates the seventh generated answer 50g, as described above in relation to FIG. 15, in consideration of the system prompt 200, that is, a combination of the standard system prompt component 202 and the custom system prompt component 204.

For example, shown in FIG. 19, the third instruction 80c may be directed at drafting an independent claim 1, for example, “Our invention is about a drone system that includes a first drone that can carry a second drone. The second drone can be lowered from the first drone when delivering a package that is carried by the second drone. The lowering is by connection mechanism between the first and second drone. Please draft an independent claim 1.” In response, the processor 12, in communication with and/or executing the generative AI module 24-1, generates the seventh answer 50g of “1. A drone system comprising: a first drone having a lifting mechanism; a second drone having a package carrying mechanism; a connection mechanism between the first and second drone, wherein the connection mechanism is configured to allow the second drone to be carried by the first drone during flight and to be lowered from the first drone by the lifting mechanism to deliver the package carried by the second drone to a destination.”

In one embodiment, the nineth project section 36i is operably coupled to the output area 48 of the third segment 38c such that, based on the generated answer 50 in the second project section 36b, the generative AI module 24-1 (executing on the one or more processor 12, for example) may extract one or more term 154. For example, the processor may extract, from the seventh generated answer 50g, a first term 154a, a second term 154b, and a third term 154c as one or more keyword 65 (FIG. 7).

In one embodiment, the processor 12 may generate the one or more keyword 65 from the one or more term 154 such that the one or more term 154 is not verbatim the one or more keyword 65. In one embodiment, extraction of the one or more term 154 into the one or more keyword 65 may be based on one or more user-defined preference, such as extraction of technical nouns, noun chunks, or other word and/or words, for example, based on grammar classification or the like. For example, as shown in FIG. 19, the processor 12 has identified a first term 154a of “first drone”, a second term 154b of “second drone”, and a third term 154c of “carried by the first drone”, and has generated a first keyword 65a of “first drone”, a second keyword 65b of “second drone”, and a third keyword 65c of “drone carrying ˜10”, respectively, thus, the third term 154c of “carried by the first drone” has been converted into the third keyword 65c of “drone carrying ˜10”, e.g., finding the words “drone” and “carrying” within 10 words of one another.

In one embodiment, extraction of terms 154 and/or generation of keyword 65 is performed automatically by the processor 12 when the seventh generated answer 50g is generated, and may, in some embodiments, be performed without user intervention.

In one embodiment, for example, when the instruction 80 is directed towards generating claims while in draft mode, the sixth tab 46f is instantiated but focus remains on the fifth tab 46e such that the user is not automatically directed away from the draft document 94. In some embodiments, the sixth tab 46f, after having been instantiated, is visible to any user with access to the electronic project 30.

In one embodiment, the one or more keyword 65 is used to create an advanced keyword query 75, which is executed in the nineth project section 36i to generate the landscape dashboard, for example, showing a patentability search for patent applications, granted patents, and/or printed publications, and the like, to identify documents relevant to the independent claim 1, as drafted in the seventh answer 50g. The nineth project section 36i may include the one or more dashboard element 150 such as a first dashboard element 150a implemented as a prior art list. In one embodiment, the prior art list may be filtered and/or sorted based on various criteria, such as relevance or publication date, to assist the user in analyzing the prior art landscape. Other of the one or more dashboard elements 150 may include, for example, a second dashboard element 150b implemented as a publication trend plot (e.g., a count of prior art publications per year), and/or a third dashboard element 150c implemented as a heatmap chart providing the count of prior art publication per year on a per-jurisdiction basis.

This embodiment is advantageous, not only for improved claim drafting thereby requiring fewer Office Actions from the USPTO, but also provides a more cost-efficient handling of the patent application process. By integrating the generative AI module's functionality of extracting terms as keywords from the generated answer 50 (e.g., a patent claim) and perform a patent search for relevant prior art documents in real-time, the computing system 10 enables the user to quickly and easily assess the novelty and non-obviousness of the proposed claim. Furthermore, this integration of functions within the electronic project system 26 reduces the need for the user to manually perform separate patent searches, thereby improving the overall efficiency of the patent application process and reducing computing needs of the electronic project system 26 on the computing system 10. The streamlined workflow offered by the computing system 10 allows the user, such as a patent attorney, to quickly identify and address any potential issues with the proposed claim while drafting, thereby reducing the likelihood of rejections by the patent office and subsequent amendments, which can be time-consuming, costly, and resource demanding.

In this way, the embodiment(s) described in relation to FIG. 19 demonstrate that the computing system 10 improves the patent application process by providing an integrated and efficient approach to claim drafting and prior art searching. These novel feature(s) not only enhance the overall functionality and user experience of the electronic project system 26, but also offers significant cost savings and efficiency gains for patent attorneys and other users involved in the patent application process.

From the above description, it is clear that the inventive concepts disclosed and claimed herein are well adapted to carry out the objects and to attain the advantages mentioned herein, as well as those inherent in the disclosure. While exemplary embodiments of the inventive concepts have been described for purposes of this disclosure, it will be understood that numerous changes may be made which will readily suggest themselves to those skilled in the art and which are accomplished within the spirit of the inventive concepts disclosed and claimed herein.

### ILLUSTRATIVE EMBODIMENTS

The following is a number list of non-limiting illustrative embodiments of the inventive concept disclosed herein:
Illustrative Embodiment 1. A method for facilitating electronic project review using a generative AI system, the method comprising:
   providing a user interface with access to multiple sessions within an electronic project;
   enabling the user to selectively switch between the sessions;
   maintaining a state-saved context for each session, including the selected source documents, previously asked questions, and generated answers;
   automatically loading the corresponding context for each session when the user switches between the sessions; and
   allowing the user to continue their work within each session from where they left off, based on the state-saved context.
Illustrative Embodiment 2. A system for managing electronic project review using a generative AI system, the system comprising:
   a user interface configured to provide access to multiple sessions within an electronic project;
   a session management component operatively coupled to the user interface, configured to maintain a state-saved context for each session, including the selected source documents, previously asked questions, and generated answers; and
   a context switching module configured to automatically load the corresponding context for each session when the user switches between the sessions, allowing the user to continue their work within each session from where they left off.
Illustrative Embodiment 3. A non-transitory computer-readable medium storing instructions for facilitating electronic project review using a generative AI system, the instructions comprising:
   providing a user interface with access to multiple sessions within an electronic project;
   enabling the user to selectively switch between the sessions;
   maintaining a state-saved context for each session, including the selected source documents, previously asked questions, and generated answers;
   automatically loading the corresponding context for each session when the user switches between the sessions; and
   allowing the user to continue their work within each session from where they left off, based on the state-saved context.
Illustrative Embodiment 4. A method for facilitating review of an electronic project comprising:
   providing a user interface configured to display an electronic project and associated project content;
   enabling a user to select a context source for a generative AI assistant;
   receiving a user input in the form of a question or instruction;
   generating a response to the user input using the generative AI assistant based on the selected context source;
   displaying the generated response along with context source information and source snippets within the user interface;
   allowing the user to interact with the generated response, context source information, and source snippets to gain confidence in the generated response.
Illustrative Embodiment 5. The method of Illustrative Embodiment 4, further comprising enabling the user to customize the arrangement of various project sections, panels, or views within the user interface.
Illustrative Embodiment 6. The method of Illustrative Embodiment 4, further comprising providing a search tool within the user interface that automatically extracts keywords from the user input and performs a keyword search across the context sources.
Illustrative Embodiment 7. The method of Illustrative Embodiment 4, further comprising enabling the user to switch between different modes of the generative AI assistant, such as a draft mode for generating content not restricted to the selected context source.
Illustrative Embodiment 8. The method of Illustrative Embodiment 4, further comprising providing a text editor within the user interface, allowing the user to copy generated responses and manually edit text to create a summary or other document.
Illustrative Embodiment 9. The method of Illustrative Embodiment 4, further comprising providing sharing options for the electronic project, allowing users to collaborate on the project and control access to specific project views or sections.
Illustrative Embodiment 10. A system for facilitating review of an electronic project, comprising:
   a processor;
   a non-transitory computer-readable medium storing instructions executable by the processor;
   a user interface configured to display an electronic project and associated project content;
   a generative AI assistant configured to generate responses to user inputs based on selected context sources;
   a search tool configured to extract keywords from user inputs and perform keyword searches across the context sources;
   a text editor configured to enable users to create and edit documents using generated responses;
   sharing options for users to collaborate on the electronic project and control access to specific project views or sections.
Illustrative Embodiment 11. The system of claim 10, further comprising means for customizing the arrangement of various project sections, panels, or views within the user interface.
Illustrative Embodiment 12. The system of claim 10, further comprising means for enabling the user to switch between different modes of the generative AI assistant.
Illustrative Embodiment 13. A non-transitory computer-readable medium storing instructions executable by a processor, the instructions when executed by the processor causing the processor to perform the method of any one of claims 4-9.
Illustrative Embodiment 14. An electronic project system, comprising:
   a processor; and
   a memory, the memory comprising a non-transitory processor-readable medium storing a generative AI assistant and processor-readable instructions that when executed by the processor cause the processor to:
      generate a user interface having a project view configured to display one or more project section, each project section having a content related to an electronic project; wherein the one or more project section comprises:
         a session management segment configured to manage one or more question-and-answer sessions;
         a context management segment configured to provide one or more context field to a user, the one or more context field indicative of one or more context source associated with the one or more question-and-answer session, the content including at least the one or more context source;
         an input-output segment configured to provide a text input field, and a generated answer field; and
         a context source indicator;
      receive one or more context field and text input field from the user interface, the one or more context field being indicative of one or more selected context source of the one or more context source and the text input field being indicative of one or more user request;
      generate, with the generative AI assistant, the generated answer to the one or more user request based at least in part on at least one of the one or more selected context source; and
      transmit the context source indicator and the generated answer to the generated answer field of the input-output segment of the user interface.
Illustrative Embodiment 15. The electronic project system of Illustrative Embodiment 14, wherein the one or more project section further comprises a mode management segment configured to provide a mode input field; and wherein the memory further comprises processor-readable instructions that further cause the processor to: determine an AI mode based on the mode input field.
Illustrative Embodiment 16. The electronic project system of Illustrative Embodiment 15, wherein the one or more project section is a first project section, the project view further comprising a second project section as a text editor section; and wherein the memory further comprises processor-readable instructions that further cause the processor to: insert at least a portion of the generated answer into the text editor section based at least in part on the determined AI mode being a draft mode.
Illustrative Embodiment 17. The electronic project system of Illustrative Embodiment 16, wherein the memory further comprises processor-readable instructions that further cause the processor to:
   receive the text input field being indicative of a second user request;
   generate, with the generative AI assistant, a second generated answer based at least in part on the one or more selected context source and the second user request;
   transmit the second generated answer to the generates answer field of the input-output segment of the user interface; and
   insert at least a portion of the generated answer into the text editor section based at least in part on the determined AI mode being a draft mode.
Illustrative Embodiment 18. The electronic project system of Illustrative Embodiment 15, wherein the AI mode is one or more of a question-and-answer mode, a draft mode, a patent claim draft mode, a patent description draft mode, a patent office action draft mode, a trademark application draft mode, a trademark office action response mode, and a patent claim chart generation mode.
Illustrative Embodiment 19. The electronic project system of Illustrative Embodiment 14, wherein the context management segment further comprises a selected context indicator operable to display a count of selected context sources; and wherein the memory further comprises processor-readable instructions that further cause the processor to:
   determine a count of the one or more context field; and
   update the selected context indicator on the user interface based on user selection of the one or more context field.
Illustrative Embodiment 20. The electronic project system of Illustrative Embodiment 14, wherein the input-output segment further comprises a context source information area field; and wherein the memory further comprises processor-readable instructions that further cause the processor to: update the context source information area field based on the at least one of the one or more selected context source.
Illustrative Embodiment 21. The electronic project system of Illustrative Embodiment 20, wherein the one or more project section further comprises a source snippet segment configured to display one or more relevant source snippet from the at least one of the one or more selected context source; and wherein the memory further comprises processor-readable instructions that further cause the processor to: provide the one or more relevant source snippet either as the processor generates, with the generative AI assistant, the generated answer or after the processor generates the generated answer.
Illustrative Embodiment 22. The electronic project system of Illustrative Embodiment 21, wherein the one or more project section is a first project section; wherein the project view further comprises a second project section, the second project section being a document viewer section operable to display a source document corresponding to at least one of the one or more selected context source; and wherein the memory further comprises processor-readable instructions that further cause the processor to: upon selection of at least one of the one or more relevant source snippet, display in the document view a source document corresponding to the at least one of the one or more relevant source snippet and the at least one of the one or more selected context source.
Illustrative Embodiment 23. The electronic project system of Illustrative Embodiment 14, wherein the project view further comprises one or more additional project section, the one or more additional project section being one of a text editor section, a search tool section, a document viewer section, and a document editor section.
Illustrative Embodiment 24. The electronic project system of Illustrative Embodiment 23, wherein the one or more additional project sections are operatively connected to the input-output segment.
Illustrative Embodiment 25. The electronic project system of Illustrative Embodiment 14, wherein the one or more project section is a first project section and wherein the input-output segment of the first project section is further configured to receive a selection input indicative of at least a portion of the generated answer from the generated answer field; wherein the project view further comprises a second project section, the second project section being a document viewer section operable to display a source document corresponding to at least one of the one or more selected context source, and wherein the memory further comprises processor-readable instructions that further cause the processor to: apply one or more snippet indicator to a corresponding source snippet of the source document based at least in part on a portion of the source document corresponding to one or more source snippet, wherein the generated answer was generated at least in part based on the one or more source snippet.
Illustrative Embodiment 26. The electronic project system of Illustrative Embodiment 14, wherein the one or more project section is a first project section and wherein the project view further comprises a second project section comprising one or more of the session management segment, the context management segment, and the input-output segment of the first project section.
Illustrative Embodiment 27. The electronic project system of Illustrative Embodiment 14, wherein the project view is a first project view, and wherein the memory further comprises processor-readable instructions that further cause the processor to: generate the user interface further having a second project view configured to display one or more project section comprising one or more of the session management segment, the context management segment, and the input-output segment of the one or more project section of the first project view.
Illustrative Embodiment 28. The electronic project system of Illustrative Embodiment 14, wherein the one or more project section is a first project section, the project view further comprising a second project section as a search tool section having a keyword pane and a search list pane; and wherein the memory further comprises processor-readable instructions that further cause the processor to: extract one or more keyword from the generated answer; and update the keyword pane of the search tool section based on the one or more extracted keywords.
Illustrative Embodiment 29. The electronic project system of Illustrative Embodiment 28, wherein the search tool section further comprises a search list pane operable to display one or more search document of the content related to the electronic project, and wherein the memory further comprises processor-readable instructions that further cause the processor to: perform a keyword search on the one or more search document listed in the search list pane.
Illustrative Embodiment 30. The electronic project system of Illustrative Embodiment 28, the memory further comprises processor-readable instructions that further cause the processor to: extract the one or more keyword from the text input field.
Illustrative Embodiment 31. The electronic project system of Illustrative Embodiment 28, wherein the project view is a first project view, and wherein the memory further comprises processor-readable instructions that further cause the processor to: generate the user interface further having a second project view configured to display a third project section as the search tool section having the keyword pane and the search list pane.
Illustrative Embodiment 32. The electronic project system of Illustrative Embodiment 28, wherein the generative AI assistant is a natural language model operable to output the generates answer as a natural language response.
Illustrative Embodiment 33. The electronic project system of Illustrative Embodiment 14, wherein the memory further comprises processor-readable instructions that further cause the processor to: generate the user interface having the project view configured to display one or more project section, wherein the one or more project section further comprises at least one context source indicator associated with each of the one or more context source.
Illustrative Embodiment 34. The electronic project system of Illustrative Embodiment 14, wherein the memory further comprises processor-readable instructions that further cause the processor to: generate the user interface having the project view configured to display one or more project section, wherein the one or more project section further comprises the context source indicator being indicative of a source document and a source document format.
Illustrative Embodiment 35. An electronic project system, comprising:
   a processor; and
   a memory, the memory comprising a non-transitory processor-readable medium storing processor-readable instructions that when executed by the processor cause the processor to:
   generate a user interface having a project view configured to display one or more project section, each project section having a content related to an electronic project;
   wherein the one or more project section comprises:
      a session management segment configured to manage one or more question-and-answer sessions;
      a context management segment configured to provide one or more context field to a user, the one or more context field indicative of one or more context source associated with the one or more question-and-answer session, the content including at least the one or more context source;
      an input-output segment configured to provide a text input field, and a generated answer field; and
      a prompt input field;
   receive one or more custom prompt input from the prompt input field of the user interface as a custom prompt input;
   receive one or more text input from the user interface, the text input being indicative of one or more user request;
   generate an answer to the one or more user request based at least in part on the custom prompt input; and
   transmit the generated answer to the generated answer field of the input-output segment of the user interface.
Illustrative Embodiment 36. The electronic project system of Illustrative Embodiment 34, wherein the one or more project section further comprises a mode management segment configured to provide a mode input field; and wherein the memory further comprises processor-readable instructions that further cause the processor to: determine a mode setting based on the mode input field.
Illustrative Embodiment 37. The electronic project system of Illustrative Embodiment 36, wherein the one or more project section is a first project section, the project view further comprising a second project section as a text editor section; and wherein the memory further comprises processor-readable instructions that further cause the processor to: insert at least a portion of the generated answer into the text editor section based at least in part on the determined mode setting being a draft mode.
Illustrative Embodiment 38. The electronic project system of Illustrative Embodiment 37, wherein the memory further comprises processor-readable instructions that further cause the processor to:
   receive the text input field being indicative of a second user request;
   generate a second answer based at least in part on the one or more custom prompt and the second user request;
   transmit the second answer to the generated answer field of the input-output segment of the user interface; and
   insert at least a portion of the second answer into the text editor section based at least in part on the determined mode setting being a draft mode.
Illustrative Embodiment 39. The electronic project system of Illustrative Embodiment 36, wherein the mode setting is one or more of a question-and-answer mode, a draft mode, a patent claim draft mode, a patent description draft mode, a patent office action draft mode, a trademark application draft mode, a trademark office action response mode, and a patent claim chart generation mode.
Illustrative Embodiment 40. The electronic project system of Illustrative Embodiment 35, wherein the memory further comprises processor-readable instructions that further cause the processor to:
   generate at least one custom prompt having a predetermined format, the at least one custom prompt based on the custom prompt input; and
   generate the answer to the one or more user request based at least in part on the at least one custom prompt.
Illustrative Embodiment 41. The electronic project system of Illustrative Embodiment 40, wherein the memory further comprises processor-readable instructions that further cause the processor to:
   receive one or more input operable to modify the at least one custom prompt into a selected custom prompt having the predetermined format; and
   generate the answer to the one or more user request based at least in part on the selected custom prompt.
Illustrative Embodiment 42. The electronic project system of claim 41, wherein the memory further stores a system prompt component and further comprises processor-readable instructions that further cause the processor to:
   generate a system prompt having the predetermined format, the system prompt based on the selected custom prompt having the predetermined format and the system prompt component; and
   generate the answer to the one or more user request based at least in part on the system prompt.
Illustrative Embodiment 43. The electronic project system of Illustrative Embodiment 35, wherein the memory further comprises processor-readable instructions that further cause the processor to:
   generate a system prompt having a predetermined format, the system prompt based on the custom prompt input and a system prompt component; and
   generate the answer to the one or more user request based at least in part on the system prompt.
Illustrative Embodiment 44. The electronic project system of Illustrative Embodiment 35, wherein the one or more project section is a first project section, the project view further comprising a second project section as a text editor section and wherein the memory further comprises processor-readable instructions that further cause the processor to:
   determine a mode setting based on a document segment selected by the user in the text editor section;
   generate a system prompt having a predetermined format, the system prompt based on the custom prompt input, a system prompt component, and the mode setting; and
   generate the answer to the one or more user request based at least in part on the system prompt.
Illustrative Embodiment 45. The electronic project system of Illustrative Embodiment 35, wherein the memory further comprises processor-readable instructions that further cause the processor to:
   generate at least one custom prompt having a predetermined format, the at least one custom prompt based on the custom prompt input;
   receive at least one input component prompt based at least in part on the text input field of the input-output segment; and
   generate the answer to the one or more user request based at least in part on the at least one custom prompt integrated with the at least one input component prompt.
Illustrative Embodiment 46. The electronic project system of Illustrative Embodiment 45, wherein the memory further comprises processor-readable instructions that further cause the processor to:
   receive one or more input operable to modify the at least one custom prompt into a selected custom prompt having the predetermined format; and
   generate the answer to the one or more user request based at least in part on the selected custom prompt integrated with the at least one input component prompt.
Illustrative Embodiment 47. The electronic project system of claim 46, wherein the memory further stores a standard system prompt component and further comprises processor-readable instructions that further cause the processor to:
   generate a system prompt having the predetermined format, the system prompt being an integration of the selected custom prompt having the predetermined format, the at least one input component prompt, and the standard system prompt component; and
   generate the answer to the one or more user request based at least in part on the system prompt.
Illustrative Embodiment 48. The electronic project system of claim 47, wherein the generated answer is a first generated answer; wherein the one or more project section further comprises a first project section, the project view further comprising a second project section as a text editor section having a draft document; the memory further comprises processor-readable instructions that further cause the processor to:
   transmit at least a portion of the first generated answer to a first location in the draft document;
   receive one or more second text input from the user interface, the second text input being indicative of one or more second user request;
   generate a second answer based at least in part on the system prompt; and
   transmit at least a portion of the second generated answer to a second location in the draft document, the second location being different from the first location.
Illustrative Embodiment 49. The electronic project system of Illustrative Embodiment 48, wherein the memory further comprises processor-readable instructions that further cause the processor to:
   transmit at least the portion of the second generated answer to the second location in the draft document, the second location being associated with the selected custom prompt.
Illustrative Embodiment 50. The electronic project system of Illustrative Embodiment 35, wherein the generated answer is a first generated answer; wherein the one or more project section further comprises a first project section, the project view further comprising a second project section as a text editor section having a draft document; the memory further storing a first standard system prompt component and a second standard system prompt component and comprising processor-readable instructions that further cause the processor to:
   generate a first system prompt having the predetermined format and associated with a first location in the draft document, the first system prompt being an integration of a first custom prompt, at least one input component prompt, and a first standard system prompt component;
   generate a second system prompt having the predetermined format and associated with a second location in the draft document, the second system prompt being an integration of a second custom prompt, at least one input component prompt, and a second standard system prompt component;
   receive one or more second text input from the user interface, the second text input being indicative of one or more second user request;
   generate the first generated answer to the one or more first user request based at least in part on the first system prompt;
   generate a second generated answer to the one or more second user request based at least in part on the second system prompt;
   transmit at least a portion of the first generated answer to the first location in the draft document; and
   transmit at least a portion of the second generated answer to the second location in the draft document.
Illustrative Embodiment 51. An electronic project system, comprising:
   a processor; and
   a memory, the memory comprising a non-transitory processor-readable medium storing processor-readable instructions that when executed by the processor cause the processor to:
      generate a user interface having a project view configured to display one or more project section, each project section having a content related to an electronic project;
      wherein the one or more project section comprises:
         a session management segment configured to manage one or more question-and-answer sessions;
         a context management segment configured to provide one or more context field to a user, the one or more context field indicative of one or more context source associated with the one or more question-and-answer session, the content including at least the one or more context source;
         an input-output segment configured to provide a text input field, and a generated answer field;
         a landscape dashboard panel having one or more dashboard element; and
         a prompt input field;
   receive one or more custom prompt input from the prompt input field of the user interface as a custom prompt input;
   receive one or more text input from the user interface, the text input being indicative of one or more user request;
   generate an answer to the one or more user request based at least in part on the custom prompt input;
   generates one or more keyword based on the answer to the one or more user request;
   determine results of an advanced keyword query based at least in part on the one or more keyword; and
   transmit the generated answer to the generated answer field of the input-output segment of the user interface and the results to at least one of the one or more dashboard element of the landscape dashboard.

The foregoing description provides illustration and description, but is not intended to be exhaustive or to limit the inventive concepts to the precise form disclosed. Modifications and variations are possible in light of the above teachings or may be acquired from practice of the methodologies set forth in the present disclosure.

Even though particular combinations of features and steps are recited in the claims and/or disclosed in the specification, these combinations are not intended to limit the disclosure. In fact, many of these features and steps may be combined in ways not specifically recited in the claims and/or disclosed in the specification. Although each dependent claim listed below may directly depend on only one other claim, the disclosure includes each dependent claim in combination with every other claim in the claim set.

Similarly, although each illustrative embodiment listed above may directly depend on only one other illustrative embodiment, the disclosure includes each illustrative embodiment in combination with every other illustrative embodiment in the set of illustrative embodiments for each mode of the inventive concepts disclosed herein.

No element, act, or instruction used in the present application should be construed as critical or essential to the disclosure unless explicitly described as such outside of the preferred embodiment. Further, the phrase “based on” is intended to mean “based, at least in part, on” unless explicitly stated otherwise.

What is claimed is:

1. An electronic project system, comprising:
a processor; and
a memory, the memory comprising a non-transitory processor-readable medium storing processor-readable instructions that when executed by the processor cause the processor to:
generate a user interface having a project view configured to display one or more project section, each project section having a content related to an electronic project;
wherein the one or more project section comprises:
a session management segment configured to manage one or more question-and-answer sessions;
a context management segment configured to provide one or more context field to a user, the one or more context field indicative of one or more context source associated with the one or more question-and-answer session, the content including at least the one or more context source;
an input-output segment configured to provide a text input field, and a generated answer field; and
a prompt input field;
receive one or more custom prompt input from the prompt input field of the user interface as a custom prompt input;
receive one or more text input from the user interface, the text input being indicative of one or more user request;
generate an answer to the one or more user request based at least in part on the custom prompt input; and
transmit the generated answer to the generated answer field of the input-output segment of the user interface.

2. The electronic project system of claim 1, wherein the one or more project section further comprises a mode management segment configured to provide a mode input field; and wherein the memory further comprises processor-readable instructions that further cause the processor to:
determine a mode setting based on the mode input field.

3. The electronic project system of claim 2, wherein the one or more project section is a first project section, the project view further comprising a second project section as a text editor section; and
wherein the memory further comprises processor-readable instructions that further cause the processor to:
insert at least a portion of the generated answer into the text editor section based at least in part on the determined mode setting being a draft mode.

4. The electronic project system of claim 3, wherein the memory further comprises processor-readable instructions that further cause the processor to:
receive the text input field being indicative of a second user request;
generate a second answer based at least in part on the one or more custom prompt and the second user request;
transmit the second answer to the generated answer field of the input-output segment of the user interface; and
insert at least a portion of the second answer into the text editor section based at least in part on the determined mode setting being a draft mode.

5. The electronic project system of claim 2, wherein the mode setting is one or more of a question-and-answer mode, a draft mode, a patent claim draft mode, a patent description draft mode, a patent office action draft mode, a trademark application draft mode, a trademark office action response mode, and a patent claim chart generation mode.

6. The electronic project system of claim 1, wherein the memory further
comprises processor-readable instructions that further cause the processor to:
generate at least one custom prompt having a predetermined format, the at least one custom prompt based on the custom prompt input; and
generate the answer to the one or more user request based at least in part on the at least one custom prompt.

7. The electronic project system of claim 6, wherein the memory further comprises processor-readable instructions that further cause the processor to:
receive one or more input operable to modify the at least one custom prompt into a selected custom prompt having the predetermined format; and
generate the answer to the one or more user request based at least in part on the selected custom prompt.

8. The electronic project system of claim 7, wherein the memory further stores a system prompt component and further comprises processor-readable instructions that further cause the processor to:
generate a system prompt having the predetermined format, the system prompt based on the selected custom prompt having the predetermined format and the system prompt component; and
generate the answer to the one or more user request based at least in part on the system prompt.

9. The electronic project system of claim 1, wherein the memory further comprises processor-readable instructions that further cause the processor to:
generate a system prompt having a predetermined format, the system prompt based on the custom prompt input and a system prompt component; and
generate the answer to the one or more user request based at least in part on the system prompt.

10. The electronic project system of claim 1, wherein the one or more project section is a first project section, the project view further comprising a second project section as a text editor section and wherein the memory further comprises processor-readable instructions that further cause the processor to:
determine a mode setting based on a document segment selected by the user in the text editor section;
generate a system prompt having a predetermined format, the system prompt based on the custom prompt input, a system prompt component, and the mode setting; and
generate the answer to the one or more user request based at least in part on the system prompt.

11. The electronic project system of claim 1, wherein the memory further comprises processor-readable instructions that further cause the processor to:
generate at least one custom prompt having a predetermined format, the at least one custom prompt based on the custom prompt input;
receive at least one input component prompt based at least in part on the text input field of the input-output segment; and
generate the answer to the one or more user request based at least in part on the at least one custom prompt integrated with the at least one input component prompt.

12. The electronic project system of claim 11, wherein the memory further comprises processor-readable instructions that further cause the processor to:
receive one or more input operable to modify the at least one custom prompt into a selected custom prompt having the predetermined format; and
generate the answer to the one or more user request based at least in part on the selected custom prompt integrated with the at least one input component prompt.

13. The electronic project system of claim 12, wherein the memory further stores a standard system prompt component and further comprises processor-readable instructions that further cause the processor to:
generate a system prompt having the predetermined format, the system prompt being an integration of the selected custom prompt having the predetermined format, the at least one input component prompt, and the standard system prompt component; and
generate the answer to the one or more user request based at least in part on the system prompt.

14. The electronic project system of claim 13, wherein the generated answer is a first generated answer; wherein the one or more project section further comprises a first project section, the project view further comprising a second project section as a text editor section having a draft document; the memory further comprises processor-readable instructions that further cause the processor to:
transmit at least a portion of the first generated answer to a first location in the draft document;
receive one or more second text input from the user interface, the second text input being indicative of one or more second user request;
generate a second answer based at least in part on the system prompt; and
transmit at least a portion of the generated second answer to a second location in the draft document, the second location being different from the first location.

15. The electronic project system of claim 14, wherein the memory further comprises processor-readable instructions that further cause the processor to:
transmit at least the portion of the generated second answer to the second location in the draft document, the second location being associated with the selected custom prompt.

16. The electronic project system of claim 1, wherein the generated answer is a first generated answer and the one or more user request is a one or more first user request; wherein the one or more project section further comprises a first project section, the project view further comprising a second project section as a text editor section having a draft document; the memory further storing a first standard system prompt component and a second standard system prompt component and comprising processor-readable instructions that further cause the processor to:
generate a first system prompt having a predetermined format and associated with a first location in the draft document, the first system prompt being an integration of a first custom prompt, at least one input component prompt, and a first standard system prompt component;
generate a second system prompt having the predetermined format and associated with a second location in the draft document, the second system prompt being an integration of a second custom prompt, at least one input component prompt, and a second standard system prompt component;
receive one or more second text input from the user interface, the second text input being indicative of one or more second user request;
generate the first generated answer to the one or more first user request based at least in part on the first system prompt;
generate a second generated answer to the one or more second user request based at least in part on the second system prompt;
transmit at least a portion of the first generated answer to the first location in the draft document; and
transmit at least a portion of the second generated answer to the second location in the draft document.
